(19) United States
(12) Patent Application Publication
(10) Pub. No.: US 2026/0260428 A1
(43) Pub. Date: Sep. 3, 2026

(54) SYSTEMS AND METHODS FOR PROVIDING XR FEEDBACK IN AN INTERACTIVE VIRTUAL EXPERIENCE

(71) Applicant: Adeia Guides Inc., San Jose, CA (US)

(72) Inventors: Charles Dasher, Lawrenceville, GA (US); Serhad Doken, Bryn Mawr, PA (US)

(21) Appl. No.: 19/066,779

(22) Filed: Feb. 28, 2025

(51) Int. Cl. G06T 19/00; G06F 3/0346; G06F 3/0354; G06T 7/73

(52) U.S. Cl. CPC G06T 19/00; G06F 3/0346; G06F 3/03545; G06T 7/74; G06T 2207/10016; G06T 2207/10048

(57) ABSTRACT

Systems and methods are provided for applying an extended reality (XR) effect to a portion of a video comprising a user. A video of a user in an environment is obtained via a camera of a user device. Infrared (IR) light is projected onto the user. IR light reflection data corresponding to the projected light reflected by an object being held by the user is detected. The IR light reflection data is compared to baseline profile data of the user. Based on the comparing, a position of the object is determined to be within a threshold proximity of the user and an XR visual effect is applied to a portion of the video comprising the user.

### BACKGROUND

This disclosure is directed to systems and methods for providing extended reality (XR) feedback or effects in a virtual experience that may simulate a real-world scenario. An illustrative virtual experience is a virtual try-on application, such as for applying cosmetic products to a user. Systems and methods are also disclosed for providing XR feedback to help guide or instruct a user during instructional content, such as a virtual tutorial.

### SUMMARY

Traditionally, cosmetic products and beauty tools have been tried on or sampled physically. However, trying on cosmetic products and trying out beauty tools in person can be unhygienic, time-consuming, and inefficient. Demand for virtual makeup try-on applications and digital beauty tools that allow users to experience realistic makeup application in a virtual environment is thus rising. In one approach, systems use augmented reality (AR) technology to provide virtual makeup try-on experiences that allow users to preview cosmetics on a live video or image. However, such approach focuses on AR or static image overlays without adapting dynamically to specific gestures or tool placements, and lacks the nuanced interactions of physical tools, such as brushes and sponges, including variations in pressure, angle, and rolling motions common in real-world makeup application. Further, such approach does not provide users with the ability to accurately control aspects of virtual makeup application such as blending, layering, and shading, and fails to provide dynamic, tactile, fine-tuned feedback to users, thereby reducing the fidelity of virtual makeup applications, and hindering the ability for the device to simulate a range of makeup tools with different textures and levels of resistance and to simulate physical sensations associated with real makeup application.

Users using a virtual makeup try-on application may use a stylus to virtually apply visual effects to a live video or image. In one approach, a stylus is tracked in three-dimensional (3D) space using emitters embedded in the stylus and position-sensitive diodes (PSDs) on a display device to triangulate the stylus's position and orientation. However, this approach is relatively hardware-intensive (e.g., it requires emitters to be embedded into the stylus) and requires complex triangulation calculations.

Other approaches to virtualize makeup application focus on recording and replaying makeup techniques through time-series data. In one approach, systems may capture progress images, stylus pressure, and movement during the creation of virtual makeup parts and uses this recorded information to guide users in reproducing the same makeup with step-by-step instructions. While this approach teaches alignment of progress images to facial landmarks for accurate placement during reproduction, the alignment is static and relies on the pre-recorded data of the makeup designer. In another approach, systems generate a 3D model of the user's face using captured images and allow the application of virtual makeup via stylus or gestures performed on a touchscreen interface. However, this approach does not provide users with an immersive experience with feedback to guide them.

There is a need for a system that accurately tracks an object that is used in an XR environment to apply visual effects in a manner that reduces hardware and computing requirements, and integrates tactile feedback and gesture sensitivity in a virtual makeup tool, allowing users to apply and view makeup in real time, whether through XR or as an overlay on a digital image.

To help address these problems, the present disclosure relates to XR applications that provide a realistic virtual experience of real-world actions in utilizing a tool to interact with an object. Disclosed techniques further relate to simulating the usage of and interaction between various types of tools, applications, and objects or surfaces. Further, this disclosure includes techniques for providing feedback to a user that is responsive to grip and gesture of an object that represents or emulates a real-world tool, and that is unique to combinations of parameters associated with tools, applications, objects, and surfaces. Disclosed techniques also relate to providing feedback to a user during a virtual tutorial associated with various virtual experiences.

While techniques are described herein for applying XR feedback to a user in the context of applying virtual makeup, it should be appreciated that the disclosed techniques may be used for any suitable application or purpose. For example, the techniques disclosed herein may be used for a variety of virtual experiences, such as remote training applications, medical applications (e.g., virtual surgery training), other consumer applications (e.g., trying on clothes, shoes, sunglasses, hats, or any other accessories or other clothing), robotics applications, and/or for any other suitable purpose, or any suitable combination thereof.

To further help address these problems, the systems and methods disclosed herein may be configured to apply an XR visual effect to a user based at least in part on infrared (IR) light reflected by an object being held by the user. In some embodiments, a system obtains a video, via a camera of a user device, comprising a user in an environment. In some implementations, the video comprises a face of the user in the environment. For example, a front-facing camera of a smartphone may capture a video of the face of the user and display the video at a display screen of the smartphone. In some implementations, the system projects infrared (IR) light onto the user in the environment. For example, the system may utilize an IR light emitter built into the user device to project the IR light onto the face of the user. Such aspects allow the system to track an object's proximity and position relative to the user without needing dedicated IR emitters on the object, therefore reducing the need for additional hardware components. In some embodiments, the system detects IR light reflection data corresponding to one or more portions of the projected IR light reflected by the object being held by the user in the environment. For example, the projected IR light may be reflected by a stylus or a cosmetic tool being held by the user.

In some implementations, the system compares the IR light reflection data to baseline profile data for the user. For example, the system may compare the IR light reflection data to baseline profile data by calculating a displacement between an IR light reflection pattern indicated by the IR light reflection data and a baseline IR light pattern indicated by the baseline profile data. The baseline profile data may comprise baseline facial profile data. This comparison enhances object tracking accuracy, allowing for precise detection of the object's position and orientation relative to the user. Based on the comparing, in some embodiments, the system determines that a position of the object is within a threshold proximity of a portion of the user. For example, the system may determine, based on the IR light reflection data, that the object is within the threshold proximity of the user by determining that the object is contacting the user based on detecting a variation in an intensity and a distribution of IR light reflections of the IR light reflection data in relation to baseline IR light reflections indicated by the baseline profile data.

In some implementations, based on the comparing, the system applies an XR visual effect to a portion of the video comprising the user. For example, the XR visual effect may be an AR cosmetic effect on the face of the user. The AR visual effect, e.g., blending, layering, shading, etc., may adjust dynamically based on the object's gestures and proximity, providing users with refined control over the virtual makeup process. In some implementations, the system receives a user selection of a type of tool, of a plurality of tools, for the stylus to emulate or represent. Each tool of the plurality of tools may be associated with one or more parameters indicating a manner of applying the visual effect for the respective tool. For example, based on receiving a user selection of an eyeliner brush, the system may cause the stylus to emulate the makeup application of an eyeliner brush (e.g., precise, thin lines on the portion of the user where the stylus is positioned or in contact with the user). In some implementations, the one or more parameters are based at least in part on stylus pressure data obtained from a sensor of the stylus in relation to the user. For example, the system may apply a darker line based on detecting a higher pressure, or a lighter line based on detecting a lighter pressure.

The techniques disclosed herein may provide users with a realistic and immersive experience by combining gesture sensitivity capturing six-degrees of freedom movements, object (e.g., stylus) sensors and sensing, and IR depth-sensing technology to accurately track the location and orientation of the object by detecting reflections from the object. Such features allow the object to respond to variations in pressure, angle, and rolling motions, enabling users to apply virtual makeup in a way that closely mirrors real-world techniques and significantly enhances tracking accuracy, allowing for precise detection of the stylus's position and orientation relative to the user. In some embodiments, sensors within the stylus capture data on tilt, roll, yaw, and pressure, enabling highly sensitive gesture detection. By combining these data points, the system can detect nuanced stylus motions, such as sweeping, tapping, and pressing, creating a responsive environment for virtual makeup application. Virtual effects—including blending, layering, and shading—can then adjust dynamically based on the stylus's gestures and proximity, providing users with refined control over the virtual makeup process.

The disclosed techniques may provide a virtual cosmetic application and/or system that allows users to apply digital makeup in a realistic, interactive environment. By integrating IR depth-sensing technology with a stylus equipped with sensors, the system tracks the stylus's position, orientation, and gestures relative to the user, allowing the stylus to function as a virtual applicator that mimics real-world makeup techniques, responding to various motions like pressure, tilt, and rotation. Using facial landmarks from a stored facial profile, the system aligns virtual effects with specific regions of the user's face, enabling precise and customizable makeup application. This approach supports real-time, hands-free makeup application on live video feeds or static images (in that the user applies the virtual makeup in a natural way by interacting with their own body, as opposed to performing the input on a touchscreen) and offers adaptable virtual tools that can simulate different applicators, such as brushes and sponges.

In some implementations, the object is a stylus, and the position of the stylus comprises data of at least one of an angle of the stylus relative to the user, a tilt of the stylus relative to the user, a yaw of the stylus relative to the user, or a roll of the stylus relative to the user. The system may apply the XR visual effect based on the position data of the stylus. For example, an eyeliner brush held at an upward angle will result in a line moving up the face, while the same eyeliner brush held at a downward angle will result in a line moving down the face. Such aspects provide the user with a more immersive experience than applying the XR visual effect without regard for the positioning of the stylus.

In some embodiments, the XR visual effect is applied to a first portion of the video corresponding to a first portion of the user. For example, eyeshadow may be virtually applied to the lid of an eye of the user. In some implementations, the system detects movement of the stylus within the threshold proximity to the user. For example, the system detects that the stylus has moved from the lid of the eye to the crease of the eye. In some embodiments, the system continually applies the XR visual effect to a second portion of the video corresponding to a second portion of the user based at least in part on the movement of the stylus. For example, the system may virtually apply the eyeshadow into the crease of the eye of the user, e.g., by blending the eyeshadow from the lid to the crease.

In some implementations, the system continually applies the XR visual effect to the portion of the video corresponding to the portion of the user based at least in part on the movement of the stylus. For example, based on detecting a patting movement of the stylus on the lid of the eye of the user, the system virtually applies more product onto the lid, resulting in a darker color. In some embodiments, wherein the threshold proximity is a first threshold proximity, the system detects that the object is within a second threshold proximity of a particular region of the user. For example, the system detects that the stylus is proximate to the left eye of the user. In some implementations, based on the detecting, the system enlarges a portion of the video comprising the particular region of the user to cause the particular region of the user to appear larger in relation to other portions of the video.

For example, the system may zoom in the video of the user such that the left eye of the face is enlarged. Such aspects allow for a more precise virtual application of the makeup. In some embodiments, the system determines, based on the IR light reflection data, a change in proximity between the object and the user. For example, the system detects that a stylus emulating a blush brush has moved two centimeters farther from the face of the user. In some implementations, based at least in part on the change in the proximity, the system adjusts the XR visual effect being applied. For example, the system applies less blush when the stylus is farther away than when the stylus is closer.

In addition, to help address these problems, systems and methods disclosed herein may be configured to provide feedback to a user during a virtual tutorial. In some embodiments, the system obtains a video, via a camera of a user device, comprising a user in an environment, wherein an object is proximate to the user. The object may be held by the user. The object may be proximate to a face of the user. For example, a front-facing camera of a smartphone may capture a video of the face of the user and display the video at a display screen of the smartphone. The object may be a stylus or a cosmetic tool. In some implementations, the system provides a virtual tutorial, to the user device, for performing an action to a particular region of the user. For example, the system may provide a virtual tutorial for applying eyeliner to the eye of the user. In some embodiments, the system monitors a position of the object in relation to the user. For example, the system may monitor the position of the object using IR light data analysis as described above.

In some implementations, while an object is within a threshold proximity of the particular region of the user, the system provides, based on the virtual tutorial, a first feedback to the user indicative of correct positioning of the object. In some embodiments, while the object is outside the threshold proximity of the particular region of the user, the system provides, based on the virtual tutorial, a second feedback to the user indicative of incorrect positioning of the object. The first feedback and the second feedback may be haptic feedback. For example, the system may cause the stylus to vibrate or pulse, which helps to enhance the virtual makeup experience by integrating dynamic haptic feedback and precise gesture sensitivity. The haptic feedback allows users to feel varying textures and resistances, mimicking the feel of different makeup tools like brushes and sponges. By responding to user-controlled parameters such as pressure, angle, and rolling motions, the system offers a more intuitive and realistic experience. In some implementations, the second feedback is of a higher magnitude than the first feedback. Each of a magnitude of the first feedback and a magnitude of the second feedback is based at least in part on the particular region of the user. For example, the system may provide stronger feedback when the stylus is near the cheek of the user than when the stylus is near the eye of the user.

In some implementations, the system applies an XR visual effect to a portion of the video comprising the user based at least in part on the position of the object. The XR visual effect may be an AR cosmetic effect on the user. For example, the system may provide a visual effect of eyeliner on the eye of the user. In some embodiments, the system detects pressure, from a pressure sensor of the stylus, of the stylus against the user. The system may provide the first feedback and/or the second feedback based at least in part on a magnitude of the detected pressure. For example, based on detecting pressure of the stylus within the correct region of the user, the system may provide haptic feedback to the stylus indicating correct positioning. In some embodiments, the system determines, from the virtual tutorial, a type of the action, wherein the first feedback and the second feedback are based at least in part on the type of the action.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative example of a process for applying an XR visual effect to a portion of a video comprising a user, in accordance with some embodiments of this disclosure.

FIG. 2 shows an illustrative example of providing feedback to a user during a virtual tutorial associated with providing an XR visual effect, in accordance with some embodiments of this disclosure.

FIG. 3 depicts illustrative user equipment devices and systems, in accordance with some embodiments of this disclosure.

FIG. 4 depicts illustrative user equipment devices and systems, in accordance with some embodiments of this disclosure.

FIG. 5 is a flowchart of a detailed illustrative process for applying an XR visual effect to a portion of a video comprising a user, in accordance with some embodiments of this disclosure.

FIG. 6 is a flowchart of a detailed illustrative process for providing feedback to a user during a virtual tutorial associated with providing an XR visual effect, in accordance with some embodiments of this disclosure.

FIG. 7 is a sequence diagram of a detailed illustrative process for applying virtual makeup in a digital environment based on IR data, in accordance with some embodiments of this disclosure.

FIG. 8 is a sequence diagram of a detailed illustrative process for adjusting virtual makeup effects based on stylus data and the type of virtual makeup, in accordance with some embodiments of this disclosure.

FIG. 9 is a sequence diagram of a detailed illustrative process for applying virtual makeup based on stylus data, in accordance with some embodiments of this disclosure.

FIG. 10 is a sequence diagram of a detailed illustrative process for using facial feature data to enhance stylus tracking accuracy, in accordance with some embodiments of this disclosure.

FIG. 11 is a sequence diagram of a detailed illustrative process for adjusting makeup effects based on stylus gestures, in accordance with some embodiments of this disclosure.

FIG. 12 is a sequence diagram of a detailed illustrative process for adjusting virtual makeup application based on stylus proximity to the face of a user, in accordance with some embodiments of this disclosure.

FIG. 13 is a sequence diagram of a detailed illustrative process for distinguishing between interactions of a stylus with a user's face and other objects within the camera's field of view, in accordance with some embodiments of this disclosure.

FIG. 14 is a sequence diagram of a detailed illustrative process for providing a zoomed-in view of specific facial areas during application to enhance precision in areas requiring fine detail, in accordance with some embodiments of this disclosure.

FIG. 15 is a sequence diagram of a detailed illustrative process for providing a virtual makeup effect based on the type of virtual tool, in accordance with some embodiments of this disclosure.

FIG. 16 is a sequence diagram of a detailed illustrative process for layering virtual makeup effects, in accordance with some embodiments of this disclosure.

FIG. 17 is a sequence diagram of a detailed illustrative process for adjusting virtual makeup application based on stylus sensor data, in accordance with some embodiments of this disclosure.

FIG. 18 is a sequence diagram of a detailed illustrative process for adapting a virtual makeup application based on stylus sensor data, in accordance with some embodiments of this disclosure.

FIG. 19 is a sequence diagram of a detailed illustrative process for providing haptic feedback based on a type of virtual tool, in accordance with some embodiments of this disclosure.

FIG. 20 is a sequence diagram of a detailed illustrative process for providing haptic feedback based on a type of virtual tool, in accordance with some embodiments of this disclosure.

FIG. 21 is a sequence diagram of a detailed illustrative process for using haptic feedback to guide users during virtual makeup tutorials, in accordance with some embodiments of this disclosure.

FIG. 22 is a sequence diagram of a detailed illustrative process for leveraging haptic feedback to indicate proximity to facial regions, in accordance with some embodiments of this disclosure.

FIG. 23 is a sequence diagram of a detailed illustrative process for tracking a stylus based on IR reflections, in accordance with some embodiments of this disclosure.

### DETAILED DESCRIPTION

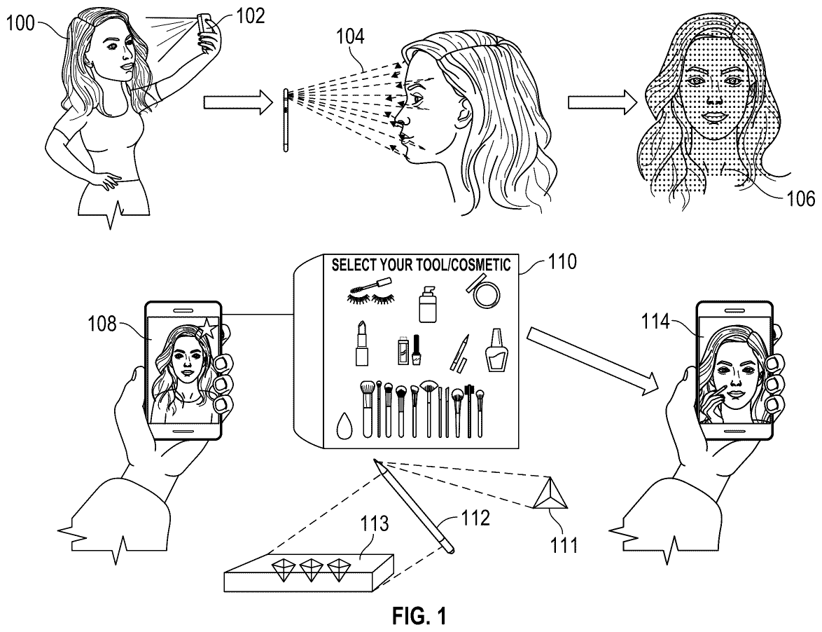

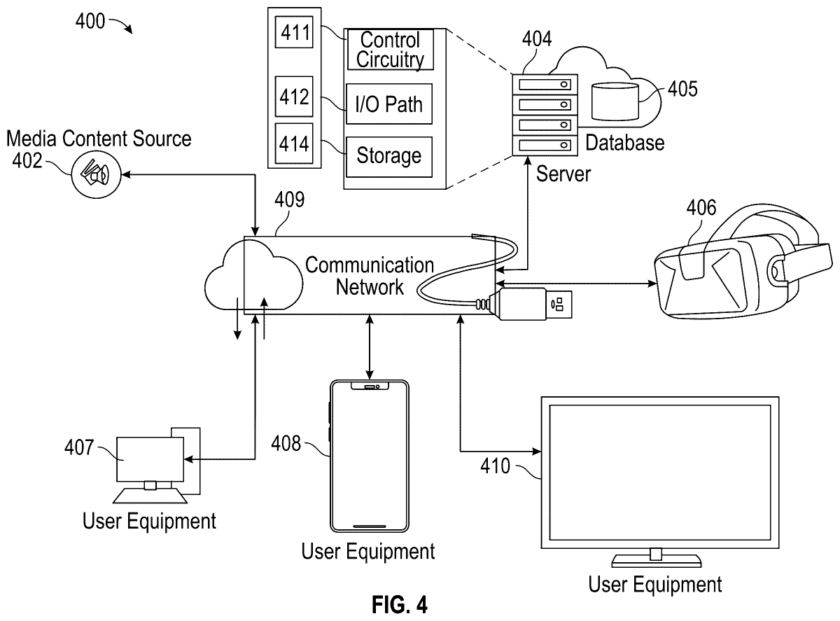

FIG. 1 shows an illustrative example of applying an XR visual effect to a portion of a video comprising a user, in accordance with some embodiments of this disclosure. FIG. 1 illustrates a system configured to perform various functions described herein. In some embodiments, the system comprises or corresponds to an application that may be executed at least in part on a server (e.g., media content source 402 and/or one or more servers 404 of FIG. 4), a user equipment device (e.g., user device 102 of FIG. 1, devices 406, 407, 408, and/or 410 of FIG. 4, such as, for example, a laptop computer, a personal computer, a desktop computer, a smart television, a smart watch or wearable device, smart glasses, a stereoscopic display, a wearable camera, XR glasses, XR goggles, an XR HMD, a near-eye display device, etc.), or any other suitable user equipment or computing device, or any combination thereof. The application and/or system may comprise or employ any suitable number of displays, sensors, or devices such as those described herein, or any other suitable software and/or hardware components, or any combination thereof.

XR may be understood as virtual reality (VR), augmented reality (AR), mixed reality (MR) technologies, immersive experiences, interactive experiences, and may provide videos, images, audio, text, haptic feedback, tactile feedback, or any other suitable data or feedback, or any suitable combination thereof. VR systems may project images to generate a three-dimensional environment to fully immerse (e.g., giving the user a sense of being in an environment) or partially immerse (e.g., giving the user the sense of looking at an environment) users in a three-dimensional, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects. In some embodiments, the environment surrounding user 100 may be a real-world environment, an AR environment (e.g., a real-world environment depicted as having virtual objects overlaid thereon), or a VR environment.

In some embodiments, the system obtains a video (or other imagery, such as, for example, a still photo or live photo or any other suitable imagery), via a camera of a user device (e.g., user device 102), comprising a user (e.g., user 100) in an environment. In some implementations, the system obtains a live video feed from a camera of user device 102. In other implementations, the system obtains a pre-captured image of user 100 from a video from storage of user device 102, a video cloud-based storage associated with user device 102, a photo from storage of user device 102, a photo from cloud-based storage associated with user device 102, any other suitable media storage associated with user device 102, or any suitable combination thereof. This flexibility may enable the system to display visual effects applied in realtime to a moving image or to a still image for more detailed adjustments.

The video may comprise the face of user 100 (and/or any other suitable portions of the user such as, for example, an arm, fingernails, toenails, lips of a user). For example, a front-facing camera of user device 102 may capture a video of the face of user 100, and the system may cause user device 102 to display the video at a display screen of user device 102. In some embodiments, at 104, the system projects infrared (IR) light onto user 100 in the environment surrounding user 100. The system may project IR light onto user 100 via an IR light emitter built into user device 102, an external IR light projector in the environment, any other suitable IR emitter, or any suitable combination thereof. For example, the system may utilize an IR light emitter built into user device 102 to project IR light dots onto the face of user 100. The system may continue to display the live feed from the camera of user device 100, e.g., at user interface 108, during the projection of the IR light. IR light is described herein as being projected onto a user and IR reflections off the user are detected, and certain actions may be performed based on such IR reflections. It should be appreciated that any suitable light or other signal may be utilized for this purpose.

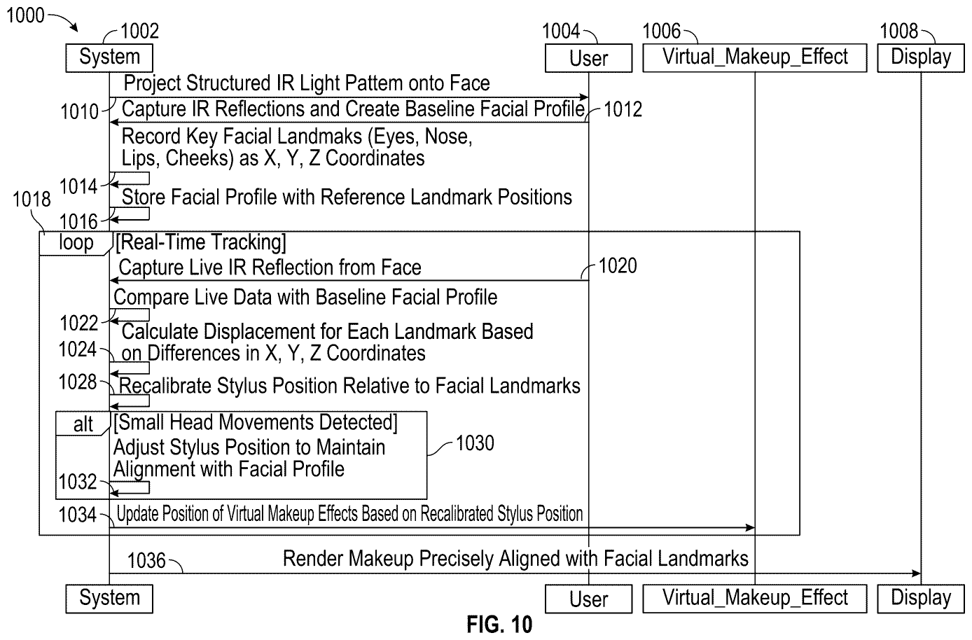

In some embodiments, at 106, the system determines initial baseline profile data for user 100. For example, the initial baseline profile data may comprise an initial, baseline IR light reflection pattern that is reflected by the face (and/or any other suitable portion) of user 100, as described in more detail below in connection with FIG. 10. In some embodiments, the initial baseline profile data may be based on current IR light reflections off user 100 detected by the system or may be stored from a previous session (e.g., when the user set up or calibrated user device 102 or an application running the system) or any other suitable previous session. In some implementations, the system detects IR light reflection data corresponding to one or more portions of the projected IR light reflected by an object in the environment. For example, user 100 may be holding an object (e.g., stylus 112) near their face. In this example, the IR light reflects not only from the face of user 100, but also from stylus 112. The IR light reflections from stylus 112 result in a different IR light reflection pattern than the baseline IR light reflection pattern of user 100 alone.

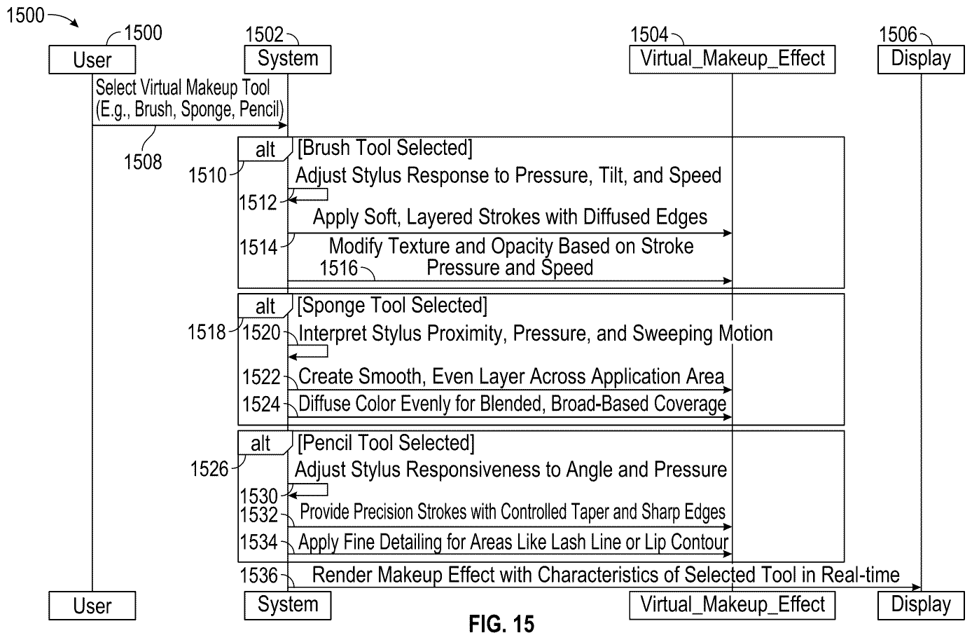

In some embodiments, the object is a cosmetic tool or a stylus (e.g., stylus 112) representing a cosmetic tool. The system may access stored configurations for various virtual cosmetic tools, such as, for example, brushes, sponges, pencils, powder puffs, spoolies, any other suitable cosmetic tool, or any suitable combination thereof. Each virtual cosmetic tool may be designed to emulate the unique characteristics and application style of different makeup applicators, as described in more detail below in connection with FIG. 15. This helps enable the system to switch between virtual tools and apply diverse application techniques that closely mimic the feel and results of real-world makeup. In some embodiments, the system receives an input (e.g., tactile input, voice input, biometric input, touchscreen input, and/or any other suitable type of input) indicating a selection of a type of tool, of a plurality of tools, for stylus 112 to emulate. For example, at user interface 108, the system displays menu 110 comprising a plurality of tools (e.g., virtual cosmetic tools) such as brushes, sponges, and pencils. In some implementations, menu 110 also includes virtual cosmetic products such as mascara, foundation, blush, nail polish, lipstick, eyeliner, lip gloss, any other suitable cosmetic product, or any suitable combination thereof.

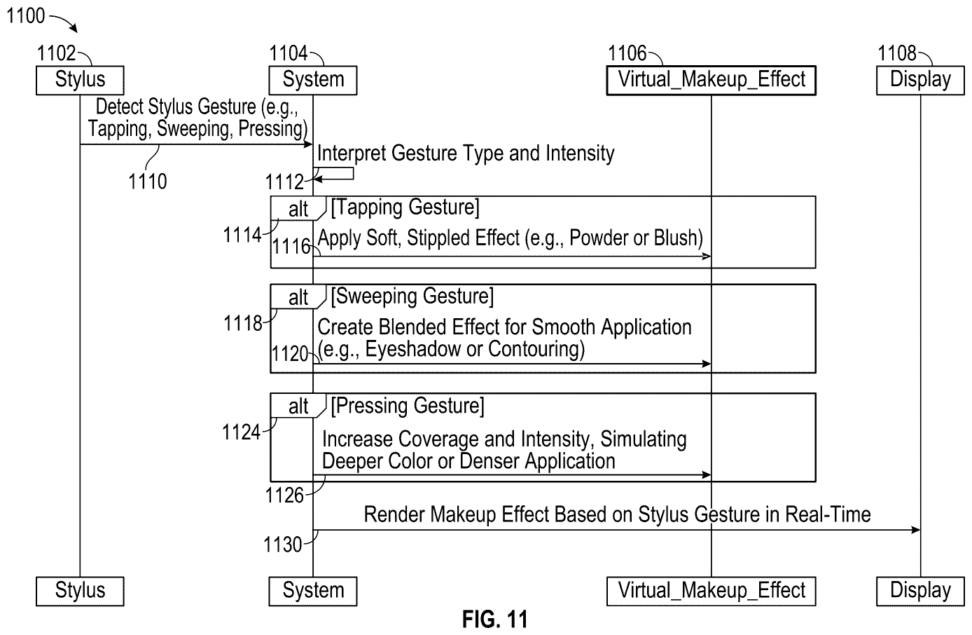

In some embodiments, a squeeze sensor on stylus 112 may be invoked, e.g., based on input received from user 100, to switch between virtual makeup tools. For example, the tools may be ordered in a circular carousel fashion so that each squeeze operation advances the virtual makeup tool to the next item in the list of virtual makeup tools. In some embodiments, stylus 112 may have connectivity (e.g., a transceiver to facilitate Bluetooth connectivity) and/or one or more batteries to power sensors or components thereof. In some embodiments, when user 100 switches from one makeup tool emulation to another makeup tool emulation, the system adjusts the impact and scope of the tool (e.g., cheek brush versus eyeliner brush) based on the nature of the tool, as described in more detail below in connection with FIG. 11. For example, a cheek brush gesture will cover an increased scope versus a muted scope for an eyeliner brush. In some implementations, the tool applicator settings can be adjusted from their default setting based on user preferences and/or user input.

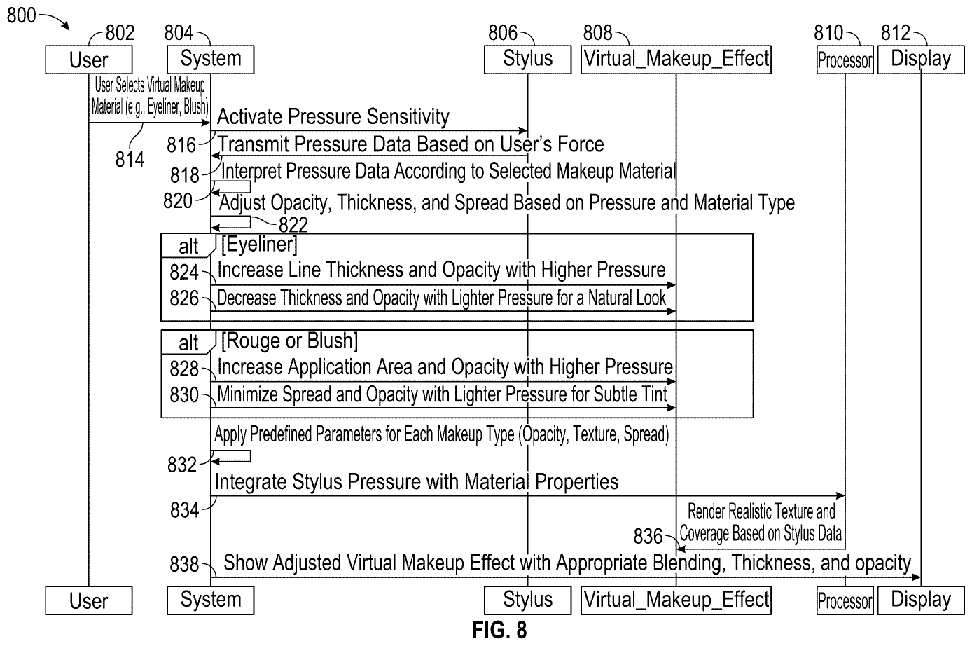

In some embodiments, each tool of the plurality of tools (e.g., identified in menu 110) is associated with one or more parameters indicating a manner of applying a visual effect for the respective tool, as described in more detail below in connection with FIG. 8. For example, the system receives selection from user 100 of a virtual blush brush to apply virtual blush for a soft, blended application. In some implementations, the one or more parameters are based at least in part on sensor data comprising stylus pressure data obtained from a sensor of stylus 112 in relation to user 100. Stylus 112 may include fiber-optic sensors, capacitance sensors, resistance sensors, conductivity sensors, any other suitable sensors, or any suitable combination thereof. In some implementations, stylus 112 incorporates a fiber-optic system in its tip, paired with embedded LEDs and sensors, to detect sensor data comprising surface properties such as oiliness, moisture, and/or texture, and/or any other suitable surface properties. The fiber-optic LEDs may emit light onto the surface, and the reflected or scattered light is captured by optical sensors. The system may analyze this sensor data for spectral variations and intensity changes, providing information about the surface characteristics of the face or other body portion of user 100.

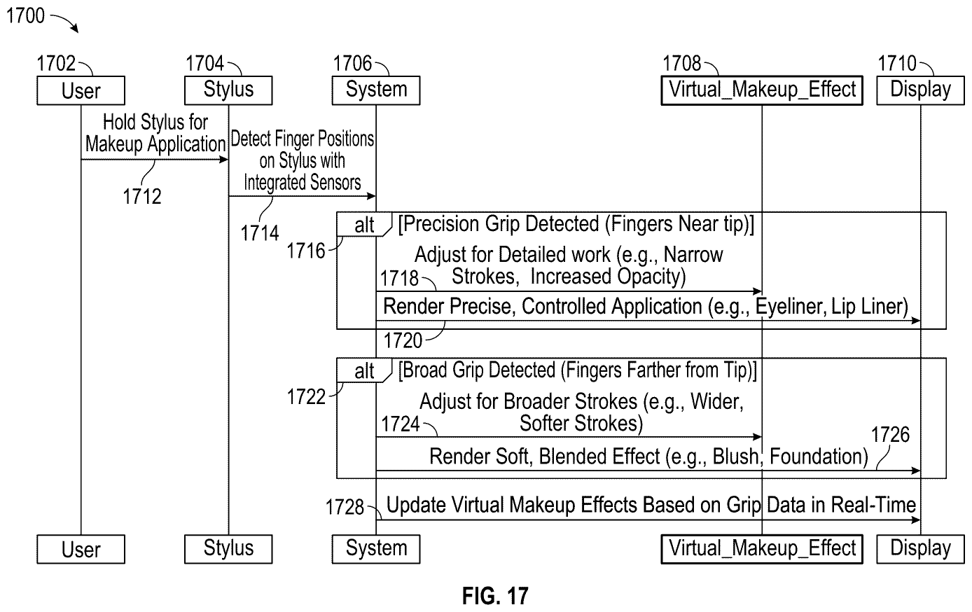

Stylus 112 may include integrated sensors that measure the pressure of the grip of the hand of user 100. The pressure and/or grip applied to stylus 112 by user 100 may modify the visual effect applied, as described in more detail below in connection with FIGS. 17-19. In some embodiments, stylus 112 may have two active ends that have sensors that can be used for virtual makeup application. For example, once a particular type of a virtual makeup tool is selected (e.g., eyebrow brush), one end of stylus 112 may simulate a spoolie and the other end may simulate an angled tapered brush, emulating the full functionality of a physical eyebrow brush. In this example, both ends of stylus 112, when active, transmit sensor measurements to the system for the intended tool parameters.

In some embodiments, the tip of stylus 112 includes a capacitance, resistance, or conductivity sensor to measure electrical properties such as, for example, hydration or oil content of skin of user 100. In some embodiments, stylus 112 comprises a proximity sensor and/or an ultrasound sensor to measure the distance between stylus 112 and the face of user 100. For example, when stylus 112 contacts a surface, the LEDs may emit light at specific wavelengths, such as infrared for detecting moisture or oiliness and visible light for texture analysis. The optical sensors capture the reflected light and analyze it in real time. In some embodiments, the capacitance sensor simultaneously measures changes in the dielectric constant to assess moisture levels, while the resistance and conductivity sensors provide further data on the surface's electrical properties, helping to enhance the accuracy of detection. The system may identify surface attributes of the skin of user 100 by combining optical and electrical data. For example, the system may detect oiliness of the skin of user 100 through spectral patterns of oil combined with capacitance measurements indicating a thin, non-conductive layer. In some embodiments, the system identifies moisture of the skin of user 100 by infrared light reflections and confirmed through increased electrical conductivity.

The system may analyze texture of the skin of user 100 via light scattering and resistance readings that distinguish between dry and damp surfaces. Texture analysis may enable the system to adjust the smoothness of foundation or blending effects, helping to provide a more realistic application that compensates for uneven or textured skin. The system may use the detected surface properties to enhance virtual makeup application by dynamically adjusting the XR visual effects to suit the user's skin characteristics. For example, for oily skin, the system applies virtual makeup with reduced shine. In another example, for dry skin, the system applies the virtual makeup with a luminous finish with simulated hydration effects. In addition to improving virtual makeup realism, the system generates personalized product recommendations based on the detected surface properties. If the sensors detect high oil levels, the system might suggest mattifying products, such as oil-control primers, powder foundations, or oil-free formulas. For dry skin, the system may recommend hydrating foundations, dewy-finish powders, or moisturizing skincare products. Texture data may inform suggestions for smoothing primers or exfoliating treatments.

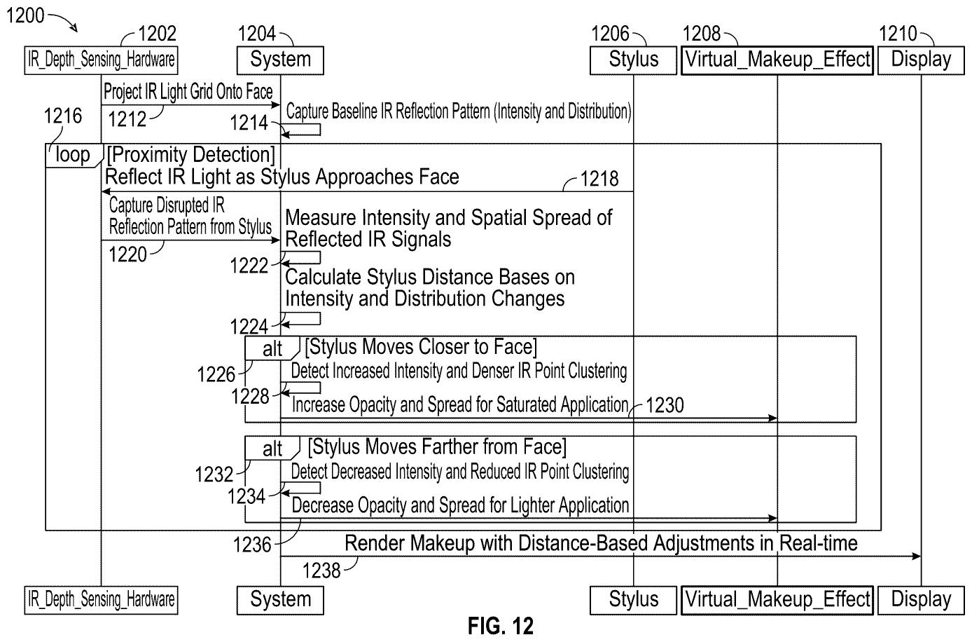

In some embodiments, the system compares the IR light reflection data to the baseline profile data for user 100. The system may compare the IR light reflection data indicated at 104 to the baseline profile data by calculating a displacement between an IR light reflection pattern indicated by the IR light reflection data and the baseline IR light pattern indicated by the baseline profile data, as described in more detail below in connection with FIGS. 10 and 12. In some embodiments, the system compares the IR light reflection data to baseline object profile data of the object (e.g., stylus 112). The baseline object profile data may enable the system to better track stylus 112 relative to user 100 by having a calibrated and deterministic understanding of how the various patterns (for example, embossed lines or ridges) reflect or refract the IR points/dots emitted by the IR light emitter.

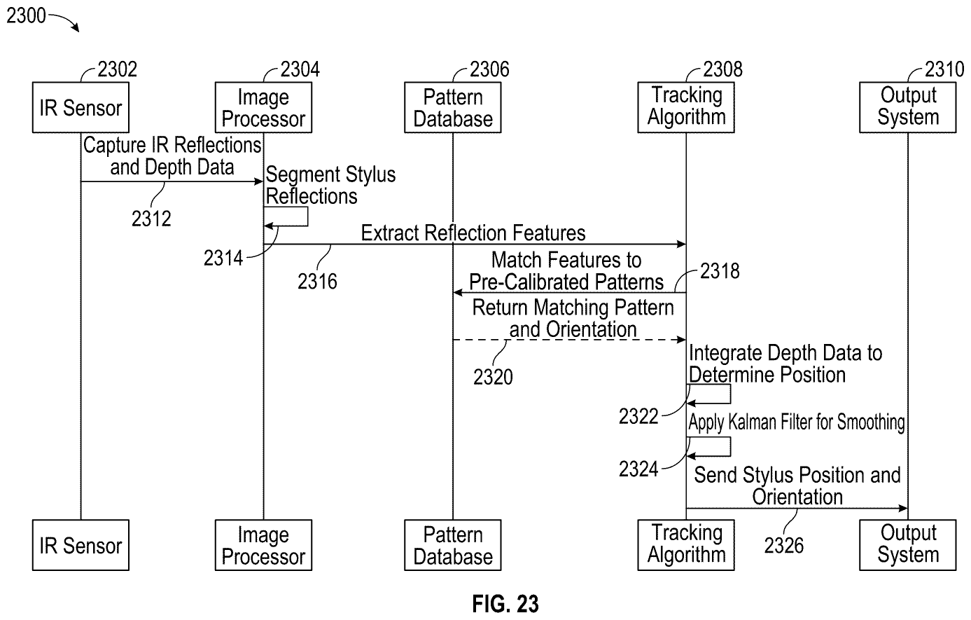

In some embodiments, stylus 112 comprises patterns (e.g., small divots with reflective coatings, embossed lines, embossed ridges, any other suitable pattern, or any suitable combination thereof), as described in more detail below in connection with FIG. 23. For example, stylus tip 111 depicts stylus 112 with one “wall” having a coating that has a controlled reflection or refraction. In another example, the enlarged view of stylus 112 (e.g., wall 113) depicts the length of stylus 112 comprising diamond-shaped divots, where one side of the diamond has a coating that has a controlled reflection or refraction. Based on the comparing, in some implementations, the system determines that a position of stylus 112 is within a threshold proximity of a portion of user 100. The threshold proximity may be predetermined by the system and/or may be selected by user 100 prior to beginning virtual makeup application session. For example, user 100 may prefer stylus 112 to touch their skin directly, while a different user may prefer stylus 112 to hover above their skin without direct contact.

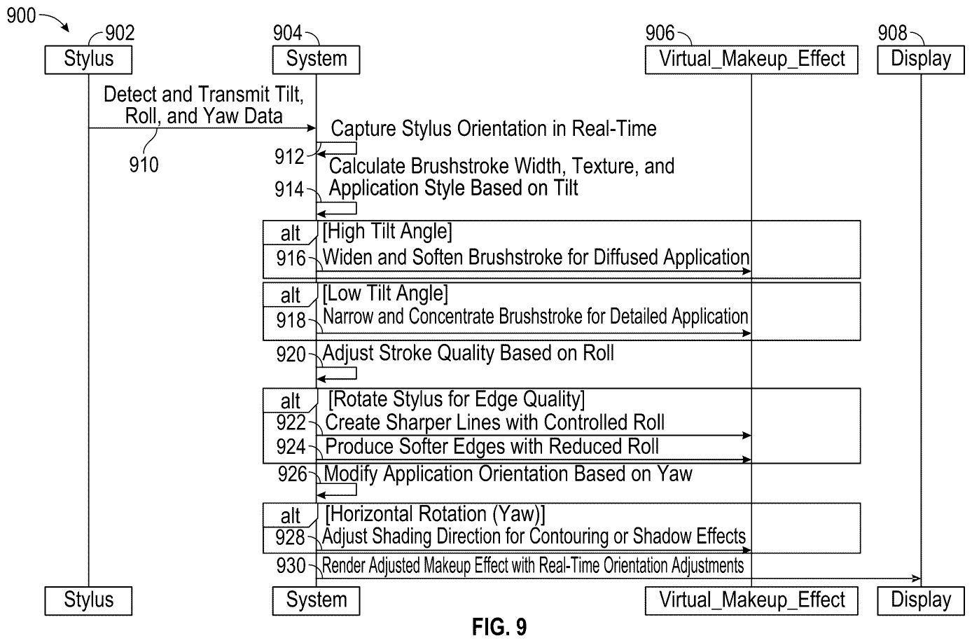

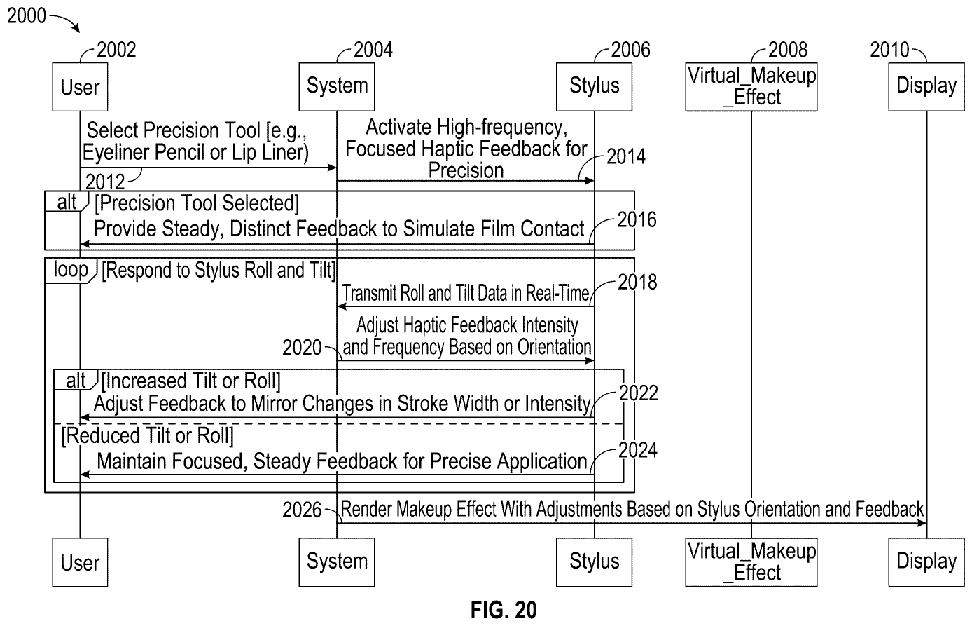

The system may determine that stylus 112 is contacting the skin of user 100 based on detecting a variation in an intensity and a distribution of IR light reflections of the IR light reflection data in relation to baseline IR light reflections indicated by the baseline profile data of user 100. In some embodiments, the position of stylus 112 comprises data of at least one of an angle of stylus 112 relative to user 100, a tilt of stylus 112 relative to user 100, a yaw of stylus 112 relative to user 100, or a roll of stylus 112 relative to user 100. The position data of stylus 112 may modify the visual effect applied to the video comprising user 100, as described in more detail below in connection with FIGS. 9 and 20.

In some embodiments, the system applies an XR visual effect to a portion of the video comprising user 100. In some embodiments, the XR visual effect may be an AR cosmetic effect. In some embodiments, the system applies the XR visual effect to the portion of the video comprising user 100 based at least in part on the type of tool, as described in more detail below in connection with FIG. 8. For example, at user interface 114, the system applies virtual blush to a first portion of the live feed video comprising the cheek of the face of user 100 (e.g., a first portion of user 100 where user 100 was holding stylus 112). In some embodiments, the system detects movement of stylus 112 within the threshold proximity to user 100. For example, the system detects movement of stylus 112 to a different region of the face of user 100 (e.g., from cheek to eyelid) via a change in IR light reflection pattern, sensor data measured by a sensor of stylus 112, any other suitable movement detection, or any suitable combination thereof. In some embodiments, the system applies the XR visual effect to a second portion of the video corresponding to a second portion of user 100 (e.g., the eyelid) based at least in part on the movement of stylus 112.

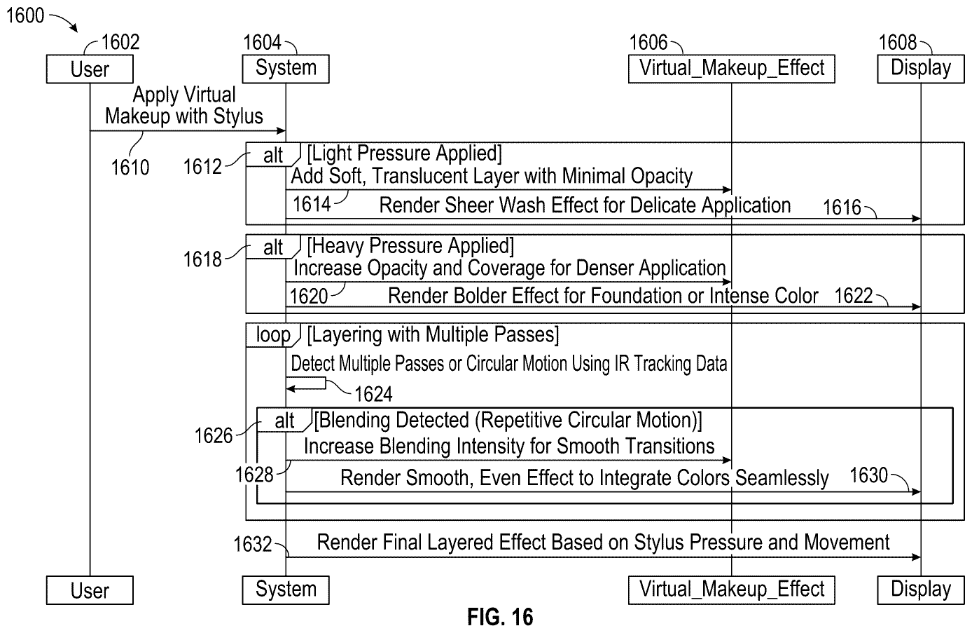

In some embodiments, the system detects movement of stylus 112 within the threshold proximity to user 100 within the same, initial portion of the video comprising user 100. For example, the system detects continual movement of stylus 112 on the cheek of user 100. The system may continually apply the XR visual effect (e.g., virtual blush) to the portion of the video corresponding to the portion of user 100 (e.g., the cheek) based at least in part on the movement of stylus 112. In some implementations, the continual application comprises layering the XR visual effect to the portion of the video corresponding to the portion of user 100, as described in more detail below in connection with FIG. 16. For example, upon detecting continuous sweeping motions of stylus 112 on the cheek of user 100, the system “layers” the application of the virtual blush for the appearance of a bolder color.

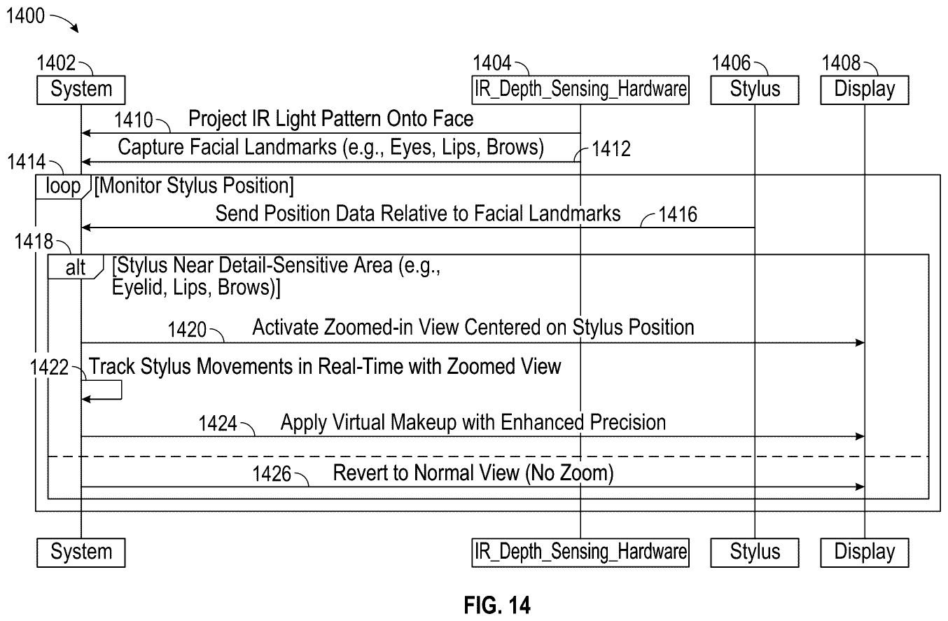

In some embodiments, the threshold proximity is a first threshold proximity, and the system detects that stylus 112 is within a second threshold proximity of a particular region of user 100. The second threshold proximity may be less than the first threshold proximity. For example, the system detects that stylus 112 is a millimeter away from the lash line of user 100 (e.g., a sensitive area). In some embodiments, based on the detecting, the system enlarges a portion of the video comprising the particular region of user 100 to cause the particular region of user 100 to appear larger in relation to other portions of the video, as described in more detail below in connection with FIG. 14. For example, the system zooms in on the portion of the video comprising the lash line of user 100 to allow user 100 to apply, e.g., eyeliner with greater precision.

In some implementations, the system determines, based on the IR light reflection data, a change in proximity between stylus 112 and user 100. For example, the system detects that stylus 112 has gone from sweeping motions directly on the cheek of user 100 to sweeping motions one millimeter above the cheek of user 100. Based at least in part on the change in the proximity, the system may adjust the XR visual effect being applied, as described in more detail below in connection with FIG. 12. For example, the system may apply a lighter wash of virtual blush or a thinner line of eyeliner. In some embodiments, when user 100 is leveraging stylus 112 for a particular type of makeup practice, say applying foundation, the system offers multiple settings such as light coverage, medium coverage and full coverage. The setting may be selected by user 100 via a user input. The setting may impact the texture rendered on the final image on user interface 114 of user device 102. The system may accomplish this by taking the sensor readings from stylus 112 and re-weighting them based on the selected setting to achieve the texture desired.

In some embodiments, user 100 uses a video conferencing application to attend a video conference. The makeup application may be integrated into the video conferencing application and/or integrated into the device running the system described above. User 100 may use stylus 112 to apply virtual makeup, using techniques describe above, before or during the video conference. The other attendees of the video conference may see user 100 with the virtual makeup applied on their respective devices running the video conferencing application. Such aspects allow a user to appear to be wearing makeup during a video conference. User 100 may also apply different virtual makeup throughout the video conference, allowing user 100 to have flexibility in their virtual appearance without having to physically change their makeup.

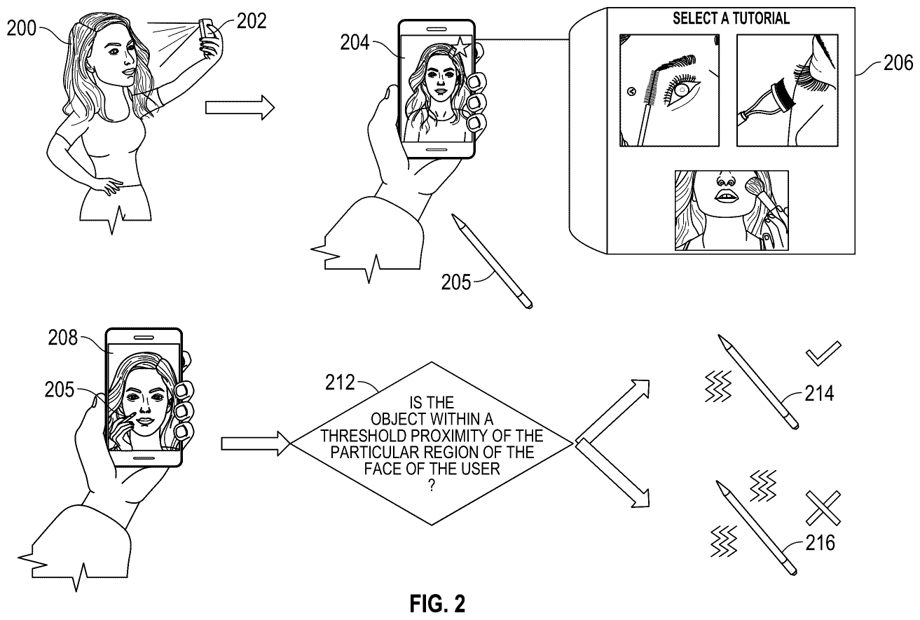

FIG. 2 shows an illustrative example of providing feedback to a user during a virtual tutorial associated with providing an XR visual effect, in accordance with some embodiments of this disclosure. FIG. 2 illustrates a system configured to perform various functions described herein. In some implementations, the system described in connection with FIG. 2 is the same system described in connection with FIG. 1. In some embodiments, the system comprises or corresponds to an application that may be executed at least in part on a server (e.g., media content source 402 and/or one or more servers 404 of FIG. 4), a user equipment device (e.g., user device 202 of FIG. 2, devices 406, 407, 408, and/or 410 of FIG. 4, such as, for example, a laptop computer, smartphone, a personal computer, a desktop computer, a smart television, a smart watch or wearable device, smart glasses, a stereoscopic display, a wearable camera, XR glasses, XR goggles, an XR HMD, a near-eye display device, etc.), or any other suitable user equipment or computing device, or any combination thereof. The application and/or system may comprise or employ any suitable number of displays, sensors, or devices such as those described herein, or any other suitable software and/or hardware components, or any combination thereof.

In some embodiments, the system obtains a video, via a camera of a user device (e.g., user device 202), comprising a user (e.g., user 200) in an environment. The video may comprise a face of user 200. In some implementations, the system obtains a live video feed from a camera of user device 202. In other implementations, the system obtains a pre-captured image of user 200 from a video from storage of user device 202, a video cloud-based storage associated with user device 202, a photo from storage of user device 202, a photo from cloud-based storage associated with user device 202, any other suitable media storage associated with user device 202, or any suitable combination thereof. In some embodiments, user 200 is holding an object (e.g., stylus 205) proximate to their face. The object may be a cosmetic tool or a stylus simulating a cosmetic tool. In some implementations, stylus 205 is the same stylus as stylus 112 described above in connection with FIG. 1. At user interface 204, in some embodiments, the system provides a plurality of virtual tutorials to user device 202 from which user 200 may select a virtual tutorial.

Each virtual tutorial may provide instruction for performing an action to a particular region of user 200 (e.g., the eyes, lips, any other suitable region of user 200, or any suitable combination thereof). For example, user interface menu 206 displays user-selectable options corresponding to an eyebrow tutorial, an eyelashes tutorial, and a blush tutorial. A tutorial may be for a particular step in the makeup application process, e.g., eyebrows, or may be for a full makeup look, e.g., everyday makeup or nighttime glam. For example, user 200 selects, via user input, a blush tutorial, as depicted at user interface 208. Each virtual tutorial may comprise a series of steps to be followed by user 200. Each step of the series of steps may indicate a correct position of stylus 205 (e.g., a correct position of stylus 205 during a blush step is near the cheekbone of user 200, while a correct position of stylus 205 during an eyebrow filling step is near the brow bone of user 200).

In some embodiments, during a virtual makeup session of a first user (e.g., a makeup instructor), each of the virtual makeup tools/types used and their application intensity, stylus sensor pressure, six degrees of freedom (DOF) movements and IR sensor data (and/or any other suitable data) may be recorded. The system may also record an accompanying video of the session and a final image of how the first user's face looked (within the video) at the end of the session. In some embodiments, IR depth sensing and computer vision techniques could be used to track real-world tools being used in a real-world application. For example, a tutorial instructor applies real makeup to their own face or to the face of another person. The system may analyze and correlate the real-world effects of the makeup application with tracked movements of the tools with respect to the user. The system may use computer vision techniques, IR depth sensing, and object/stylus sensor data to determine “correct” positioning data during the real-world demonstration. In some implementations, the system compares the determined, correct positioning data with IR light reflection data, and other sensor data during the virtual tutorial to produce feedback and guidance.

The system may enable other users to browse the video recordings of such sessions or view the final image. For example, a second user may decide to download the settings and the live metadata recorded during the session and apply the virtual makeup to themself. In some embodiments, a second user may decide which video metadata they will download based on other user interactions with the virtual makeup session leveraging the first user's instructions (e.g., likes, comments, reactions, views, any other suitable user interaction, or any suitable combination thereof). The system may tag the metadata and timestamps alongside the clip that they are associated with. In some embodiments, the second user may search and choose certain sections of the video session and download only the relevant metadata of the virtual makeup tool(s) used for its own application. This metadata may also be cross matched with the face type (e.g., skin type, face shape, skin color, etc.) of the first user. During a search session by a second user, they may choose a virtual makeup video session based on a classified face type.

In some embodiments, the system monitors a position of stylus 205 in relation to user 200. In some embodiments, the system projects IR light onto user 200 in the environment using techniques described above in connection with FIG. 1. The system may detect IR light reflection data corresponding to the projected IR light reflected by stylus 205. The system may compare the IR light reflection data to baseline profile data of user 200 using techniques described above in connection with FIG. 1. Based on the comparing, the system determines the position of stylus 205. At 212, the system may determine whether stylus 205 is within a threshold proximity of the particular region of user 200. The threshold proximity may be predetermined (or dynamically determined) by the system or may be selected by user 200. For example, using techniques described above in connection with FIG. 1, the system determines that user 200 is holding stylus 205 against their cheek. In another example, the system determines that user 200 is holding stylus 205 six inches away from their cheek.

The system may determine whether stylus 205 is within the threshold proximity by identifying a current step of the virtual tutorial. Such current step may indicate the correct positioning of the object for the current step. For example, the current step of a tutorial indicates that stylus 205 should be positioned near the front of the eyebrow of user 200. While stylus 205 is within the threshold proximity, in some implementations, at 214, the system provides, based on the virtual tutorial, first feedback to user 200 indicative of correct positioning of stylus 205. While stylus 205 is outside the threshold proximity of the particular region of user 200, in some implementations, at 216, the system provides, based on the virtual tutorial, second feedback to user 200 indicative of incorrect positioning of stylus 205.

In some embodiments, the first feedback and the second feedback are different types of haptic feedback. For example, stylus 205 may be embedded with actuators that vibrate based on the positioning of stylus 205. In some implementations, the second feedback is of a higher magnitude (e.g., higher intensity) than the first feedback (or vice versa). Additionally or alternatively, stylus 205 vibrates at a higher frequency and/or for a longer amount of time when stylus 205 has incorrect positioning instead of correct positioning (or vice versa). In some embodiments, the first feedback is of a higher magnitude than the second feedback. In some embodiments, each of a magnitude of the first feedback and a magnitude of the second feedback is based at least in part on the particular region of user 200. For example, the system may cause stylus 205 to vibrate with a higher intensity when stylus 205 is positioned near the cheek of user 200 and a lower intensity when stylus 205 is positioned near the eyelid of user 200. Such aspects enable the system to protect sensitive regions of the user, e.g., the eyelids, to promote safe makeup application. Such aspects also enable the system to emphasize which steps in the tutorial are most important to the overall visual effect. In some embodiments, stylus 205 vibrates with higher frequency and/or for a longer amount of time when stylus 205 is in direct contact with the face of the user than when stylus 205 is just hovering above the face of the user.

In some implementations, the system detects pressure, from a pressure sensor of stylus 205, of stylus 205 against user 200. In some embodiments, the system provides the first feedback based at least in part on a magnitude of the detected pressure. In some embodiments, the system provides the second feedback based at least in part on a magnitude of the detected pressure. For example, upon detecting high pressure from a pressure sensor of stylus 205, the system may provide stronger feedback to stylus 205. In some embodiments, the first feedback and/or the second feedback provided by the system are displayed on a display of user device 202 (e.g., user interface 208) and/or audibly played from user device 202. For example, upon detecting that stylus 205 is within the threshold proximity of the particular region of user 200, the system may display a notification, at user interface 208 (or otherwise output, e.g., an audio notification), stating that the positioning of 205 is correct. In another example, upon detecting that stylus 205 is outside the threshold proximity of the particular region of user 200, the system may display a visual notification, or play an audible notification, via a speaker of user device 202, stating that the positioning of stylus 205 is incorrect.

In some embodiments, the system determines, from the virtual tutorial, a type of action, and the first feedback and the second feedback may be based at least in part on the type of the action, as described in more detail below in connection with FIG. 11. For example, if the system detects that stylus 205 is tapping against the cheek of user 200, the system may provide stylus 205 with pulsing feedback. In another example, if the system detects that stylus 205 is sweeping against the cheek of user 200, the system may provide stylus 205 with continuous feedback. In some embodiments, the system applies an extended reality (XR) visual effect to a portion of the video comprising the user based at least in part on the position of the object. For example, the XR visual effect is an AR cosmetic effect on the portion of the video comprising user 200. In some implementations, while stylus 205 is outside the threshold proximity of the particular region of user 200, the system stops applying the XR visual effect to user 200. In some embodiments, during a virtual makeup tutorial session, the system provides user 200 with an option to enable a mode that, when stylus 205 touches an area that is sparse, such area may be filled in the final image. This mode may show a simulation to user 200 of a potential scenario that they may experiment with. For example, during an eyebrow tutorial, user 200 may press stylus 205 to a sparse area on the eyebrow. In this example, the system applies an AR effect at the sparse area so that the eyebrow, at user interface 208 of user device 202, appears fuller and darker.

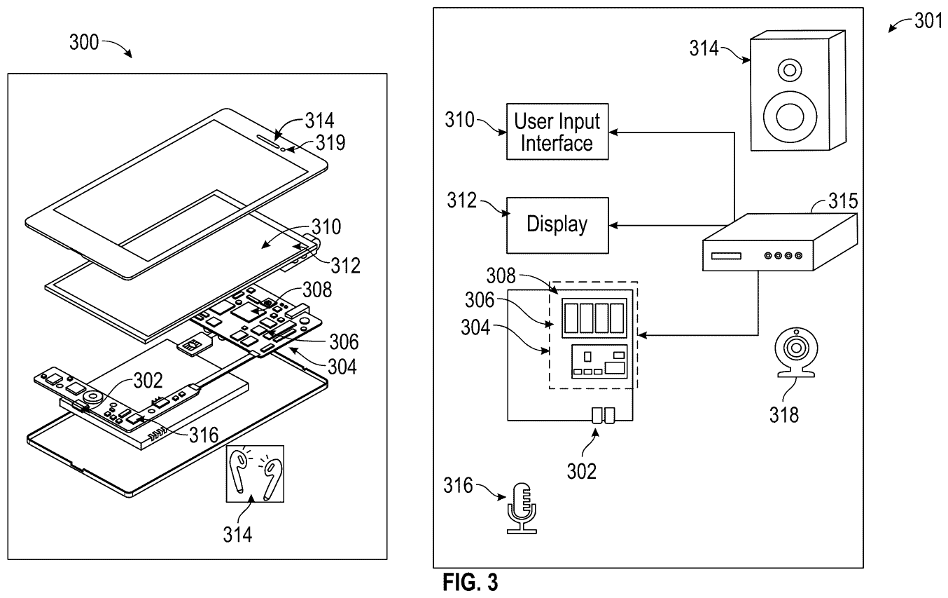

FIGS. 3-4 describe illustrative devices, systems, servers, and related hardware for applying an XR visual effect to a user and providing feedback to a user during a virtual tutorial associated with providing an XR visual effect, in accordance with some embodiments of the present disclosure. FIG. 3 shows generalized embodiments of illustrative user equipment 300 and 301, which may correspond to, e.g., user device 102 of FIG. 1. For example, user equipment 300 may be a smartphone device, a tablet, a near-eye display device, an XR device, or any other suitable device capable of participating in a XR environment, e.g., locally or over a communication network. In another example, user equipment 301 may be a user television equipment system or device. User equipment 301 may include set-top box 315. Set-top box 315 may be communicatively connected to microphone 316, audio output equipment 314 (e.g., speaker or headphones), and display 312. In some embodiments, microphone 316 may receive audio corresponding to a voice of a user and/or ambient audio data. In some embodiments, display 312 may be a television display or a computer display. In some embodiments, set-top box 315 may be communicatively connected to user input interface 310. In some embodiments, user input interface 310 may be a remote-control device. Set-top box 315 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 4. In some embodiments, user equipment 300 may comprise any suitable number of sensors (e.g., gyroscope or gyrometer, or accelerometer, etc.), and/or a GPS module (e.g., in communication with one or more servers and/or cell towers and/or satellites) to ascertain a location of user equipment 300. In some embodiments, user equipment 300 comprises a rechargeable battery that is configured to provide power to the components of the device.

Each one of user equipment 300 and user equipment 301 may receive content and data via input/output (I/O) path 302. I/O path 302 may provide content (e.g., broadcast programming, on-demand programming, internet content, content available over a local area network (LAN) or wide area network (WAN), and/or other content) and data to control circuitry 304, which may comprise processing circuitry 306 and storage 308. Control circuitry 304 may be used to send and receive commands, requests, and other suitable data using I/O path 302, which may comprise I/O circuitry. I/O path 302 may connect control circuitry 304 to one or more communications paths (described below). I/O functions may be provided by one or more of these communications paths but are shown as a single path in FIG. 4 to avoid overcomplicating the drawing. While set-top box 315 is shown in FIG. 3 for illustration, any suitable computing device having processing circuitry, control circuitry, and storage may be used in accordance with the present disclosure. For example, set-top box 315 may be replaced by, or complemented by, a personal computer (e.g., a notebook, a laptop, a desktop), a smartphone (e.g., user equipment 300), an XR device, a tablet, a network-based server hosting a user-accessible client device, a non-user-owned device, any other suitable device, or any combination thereof.

Control circuitry 304 may be based on any suitable control circuitry such as processing circuitry 306. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 304 executes instructions for the system (as described in connection with FIGS. 1-2) stored in memory (e.g., storage 308). Specifically, control circuitry 304 may be instructed by the system to perform the functions discussed above and below. In some implementations, processing or actions performed by control circuitry 304 may be based on instructions received from the system.

In client/server-based embodiments, control circuitry 304 may include communications circuitry suitable for communicating with a server or other networks or servers. The system may be a stand-alone application implemented on a device or a server. The application may be implemented as software or a set of executable instructions. The instructions for performing any of the embodiments discussed herein of the application may be encoded on non-transitory computer-readable media (e.g., a hard drive, random-access memory on a DRAM integrated circuit, read-only memory on a BLU-RAY disk, etc.). For example, in FIG. 3, the instructions may be stored in storage 308, and executed by control circuitry 304 of a user equipment 300.

In some embodiments, the application may be a client/server application where only the client application resides on user equipment 300, and a server application resides on an external server (e.g., server 404 and/or media content source 402). For example, the application may be implemented partially as a client application on control circuitry 304 of user equipment 300 and partially on server 404 as a server application running on control circuitry 411. Server 404 may be a part of a local area network with one or more of user equipment 300, 301 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 404 and/or an edge computing device), referred to as “the cloud.” User equipment 300 may be a cloud client that relies on the cloud computing capabilities from server 404 to generate personalized engagement options in a VR environment.

Control circuitry 304 may include communications circuitry suitable for communicating with a server, edge computing systems and devices, a table or database server, or other networks or servers. The instructions for carrying out the above-mentioned functionality may be stored on a server (which is described in more detail in connection with FIG. 4). Communications circuitry may include a cable modem, an integrated services digital network (ISDN) modem, a digital subscriber line (DSL) modem, a telephone modem, an Ethernet card, or a wireless modem for communications with other equipment, or any other suitable communications circuitry. Such communications may involve the internet or any other suitable communication networks or paths (which is described in more detail in connection with FIG. 4). In addition, communications circuitry may include circuitry that enables peer-to-peer communication of user equipment, or communication of user equipment in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage 308 may be used to store various types of content described herein as well as application data described above. Nonvolatile memory may also be used (e.g., to launch a boot-up routine and other instructions). Cloud-based storage, described in relation to FIG. 3, may be used to supplement storage 308 or instead of storage 308. Non-transitory memory may store instructions that, when executed by control circuitry, I/O circuitry, any other suitable circuitry or combination thereof, executes functions of an application as described above.

Control circuitry 304 may include video generating circuitry and tuning circuitry, such as one or more analog tuners, one or more MPEG-2 decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 304 may also include scaler circuitry for upconverting and downconverting content into the preferred output format of user equipment 300. Control circuitry 304 may also include digital-to-analog converter circuitry and analog-to-digital converter circuitry for converting between digital and analog signals. The tuning and encoding circuitry may be used by user equipment 300, 301 to receive and to display, to play, or to record content. The tuning and encoding circuitry may also be used to receive video communication session data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

Control circuitry 304 may receive instruction from a user by way of user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of each one of user equipment 300 and user equipment 301. For example, display 312 may be a touchscreen or touch-sensitive display. In such circumstances, user input interface 310 may be integrated with or combined with display 312. In some embodiments, user input interface 310 includes a remote-control device having one or more microphones, buttons, keypads, any other components configured to receive user input or combinations thereof. For example, user input interface 310 may include a handheld remote-control device having an alphanumeric keypad and option buttons. In a further example, user input interface 310 may include a handheld remote-control device having a microphone and control circuitry configured to receive and identify voice commands and transmit information to set-top box 315.

Audio output equipment 314 may be integrated with or combined with display 312. Display 312 may be one or more of a monitor, television, liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 312. Audio output equipment 314 may be provided as integrated with other elements of each one of user equipment 300 and user equipment 301 or may be stand-alone units. An audio component of videos and other content displayed on display 312 may be played through speakers (or headphones) of audio output equipment 314. In some embodiments, audio may be distributed to a receiver (not shown), which processes and outputs the audio via speakers of audio output equipment 314. In some embodiments, for example, control circuitry 304 is configured to provide audio cues to a user, or other audio feedback to a user, using speakers of audio output equipment 314. There may be a separate microphone 316 or audio output equipment 314 may include a microphone configured to receive audio input such as voice commands or speech. For example, a user may speak letters or words that are received by the microphone and converted to text by control circuitry 304. In a further example, a user may voice commands that are received by a microphone and recognized by control circuitry 304. Camera 318 may be any suitable video camera integrated with the equipment or externally connected. Camera 318 may be a digital camera comprising a charge-coupled device (CCD) and/or a complementary metal-oxide semiconductor (CMOS) image sensor. Camera 318 may be an analog camera that converts to digital images via a video card.

The application may be implemented using any suitable architecture. For example, it may be a stand-alone application wholly implemented on each one of user equipment 300 and user equipment 301. In such an approach, instructions of the application may be stored locally (e.g., in storage 308), and data for use by the application is downloaded on a periodic basis (e.g., from an out-of-band feed, from an internet resource, or using another suitable approach). Control circuitry 304 may retrieve instructions of the application from storage 308 and process the instructions to provide video conferencing functionality and generate any of the displays discussed herein. Based on the processed instructions, control circuitry 304 may determine what action to perform when input is received from user input interface 310. For example, movement of a cursor on a display up/down may be indicated by the processed instructions when user input interface 310 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, random access memory (RAM), etc.

Control circuitry 304 may allow a user to provide user profile information or may automatically compile user profile information. For example, control circuitry 304 may access and monitor network data, video data, audio data, processing data, content consumption data, and/or any other suitable data being accessed by a first user (e.g., user 102 of FIG. 1). Control circuitry 304 may obtain all or part of other user profiles that are related to a particular user (e.g., via social media networks), and/or obtain information about the user from other sources that control circuitry 304 may access. As a result, a user can be provided with a unified experience across the user's different devices.

In some embodiments, the application is a client/server-based application. Data for use by a thick or thin client implemented on each one of user equipment 300 and user equipment 301 may be retrieved on demand by issuing requests to a server remote to each one of user equipment 300 and user equipment 301. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on user equipment 300. This way, the processing of the instructions is performed remotely by the server while the resulting displays (e.g., that may include text, a keyboard, or other visuals) are provided locally on user equipment 300. User equipment 300 may receive inputs from the user via user input interface 310 and transmit those inputs to the remote server for processing and generating the corresponding displays. For example, user equipment 300 may transmit a communication to the remote server indicating that an up/down button was selected via user input interface 310. The remote server may process instructions in accordance with that input and generate a display of the application corresponding to the input (e.g., a display that moves a cursor up/down). The generated display is then transmitted to user equipment 300 for presentation to the user.

In some embodiments, the application may be downloaded and interpreted or otherwise run by an interpreter or virtual machine (run by control circuitry 304). In some embodiments, the application may be encoded in the ETV Binary Interchange Format (EBIF), received by control circuitry 304 as part of a suitable feed, and interpreted by a user agent running on control circuitry 304. For example, the application may be an EBIF application. In some embodiments, the application may be defined by a series of JAVA-based files that are received and run by a local virtual machine or other suitable middleware executed by control circuitry 304. In some of such embodiments (e.g., those employing MPEG-2, MPEG-4, HEVC or any other suitable digital media encoding schemes), the application may be, for example, encoded and transmitted in an MPEG-2 object carousel with the MPEG audio and video packets of a program.

As shown in FIG. 4, user equipment 406, 407, 408, 410 (which may correspond to user equipment, e.g., user device 102 of FIG. 1) may be coupled to communication network 409. Communication network 409 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 409) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 4 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 409.

System 400 may comprise media content source 402, one or more servers 404, and/or one or more edge computing devices. In some embodiments, the application may be executed at one or more of control circuitry 411 of server 404 (and/or control circuitry of user equipment 406, 407, 408, 410 and/or control circuitry of one or more edge computing devices). In some embodiments, the media content source and/or server 404 may be configured to host or otherwise facilitate video communication sessions between user equipment 406, 407, 408, 410 and/or any other suitable user equipment, and/or host or otherwise be in communication (e.g., over communication network 409) with one or more social network services.

In some embodiments, server 404 may include control circuitry 411 and storage 414 (e.g., RAM, ROM, Hard Disk, Removable Disk, etc.). Storage 414 may store one or more databases. Server 404 may also include an I/O path 412. In some embodiments, I/O path 412 is an I/O circuitry. I/O circuitry may be a NIC card, audio output device, mouse, keyboard card, any other suitable I/O circuitry device or combination thereof. I/O path 412 may provide video conferencing data, device information, or other data, over a local area network (LAN) or wide area network (WAN), and/or other content and data to control circuitry 411, which may include processing circuitry, and storage 414. Control circuitry 411 may be used to send and receive commands, requests, and other suitable data using I/O path 412, which may comprise I/O circuitry. I/O path 412 may connect control circuitry 411 to one or more communications paths.

Control circuitry 411 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 411 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 411 executes instructions for an emulation system application stored in memory (e.g., the storage 414). Memory may be an electronic storage device provided as storage 414 that is part of control circuitry 411. Memory may store instruction to run the application.

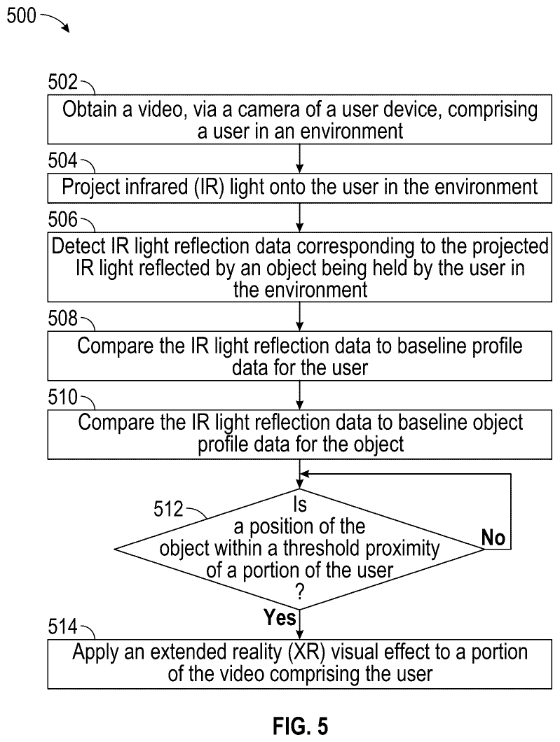

FIG. 5 is a flowchart of a detailed illustrative process for applying an XR visual effect to a user, in accordance with some embodiments of this disclosure. In various embodiments, the individual steps of process 500 may be implemented by one or more components of the devices, methods, and systems of FIG. 1 and FIGS. 3-4, and may be performed in combination with any of the other processes and aspects described herein. Although the present disclosure may describe certain steps of process 500 (and of other processes described herein) as being implemented by certain components of the devices, methods, and systems of FIG. 1 and FIGS. 3-4, this is for purposes of illustration only, and it should be understood that other components of the devices, methods, and systems of FIG. 2 and FIGS. 6-23 may implement those steps instead.

In some embodiments, at 502, control circuitry (e.g., control circuitry 304 of FIG. 3 and/or control circuitry 411 of FIG. 4) obtains a video, via a camera of a user device, comprising a user in an environment. In some implementations, at 504, control circuitry projects IR light onto the user in the environment. In some embodiments, at 506, control circuitry detects IR light reflection data corresponding to the projected light reflected by an object being held by the user in the environment. The object may be a stylus as described above in connection with FIG. 1. In some implementations, at 508, control circuitry compares the IR light reflection data to baseline facial profile data for the user. In some embodiments, at 510, control circuitry compares the IR light reflection data to baseline object profile data for the object. In some embodiments, at 512, control circuitry determines whether a position of the object is within a threshold proximity of a portion of the user. If control circuitry determines that the position of the object is not within a threshold proximity of the portion of the user, control circuitry may return to 512. If control circuitry determines that the position of the object is within the portion of the face of the user, control circuitry may proceed to 514. In some implementations, at 514, control circuitry applies an XR visual effect to a portion of the video comprising the user.

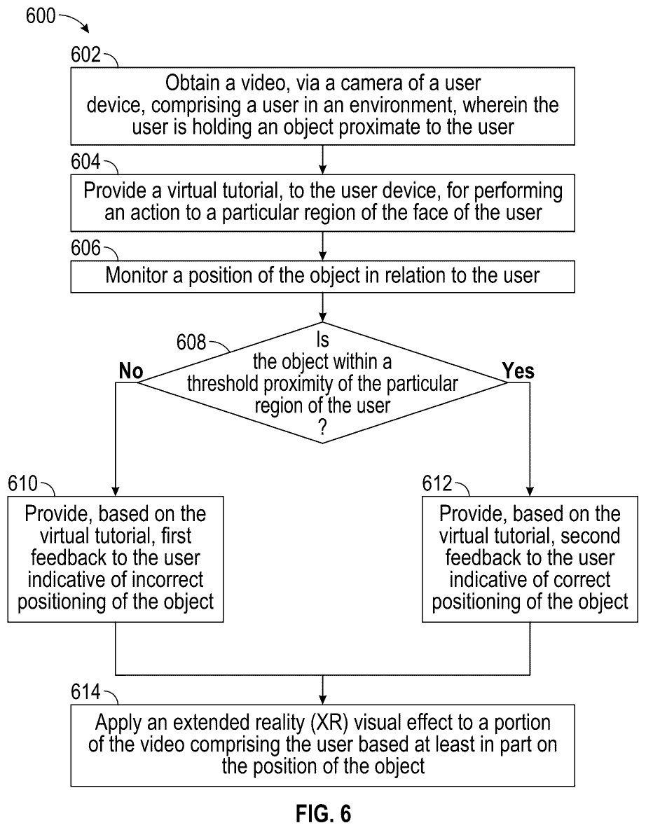

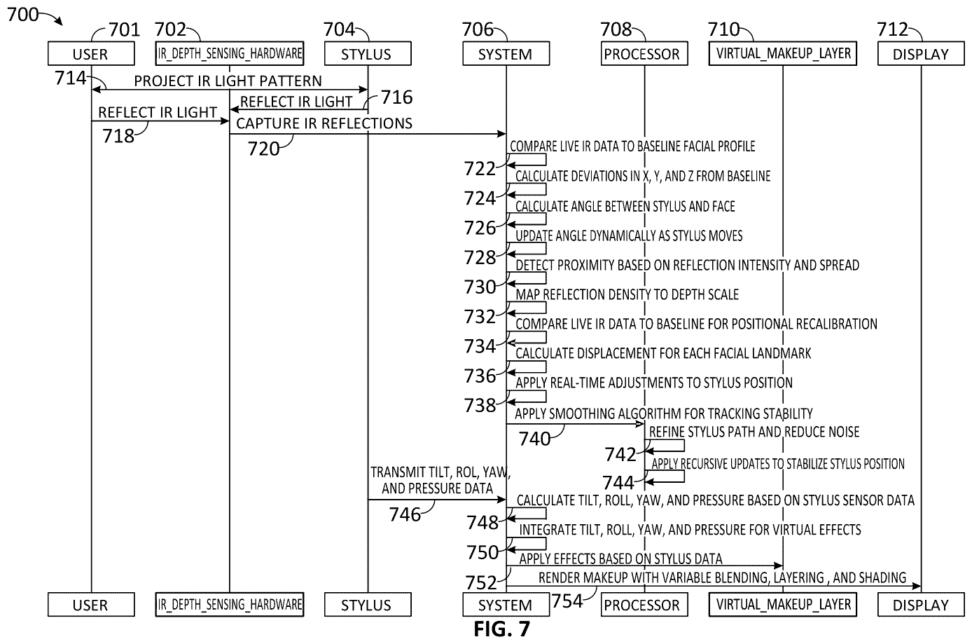

FIG. 6 is a flowchart of a detailed illustrative process for providing feedback to a user during a virtual tutorial associated with providing an XR visual effect, in accordance with some embodiments of this disclosure. In various embodiments, the individual steps of process 600 may be implemented by one or more components of the devices, methods, and systems of FIG. 1 and FIGS. 3-4, and may be performed in combination with any of the other processes and aspects described herein. Although the present disclosure may describe certain steps of process 600 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIG. 5, and FIGS. 7-23 may implement those steps instead.

In some embodiments, at 602, control circuitry (e.g., control circuitry 304 of FIG. 3 and/or control circuitry 411 of FIG. 4) obtains a video, via a camera of a user device, comprising a face of a user in an environment, wherein the user is holding an object proximate to the face of the user. In some implementations, at 604, control circuitry provides a virtual tutorial, to the user device, for performing an action to a particular region of the face of the user. In some embodiments, at 606, control circuitry monitors a position of the object in relation to the face of the user. In some implementations, at 608, control circuitry determines whether the object is within a threshold proximity of the particular region of the face of the user. If control circuitry determines that the position of the object is not within the portion of the face of the user, control circuitry may proceed to 610. In some embodiments, at 610, control circuitry provides, based on the virtual tutorial, first feedback to the user indicative of incorrect positioning of the object. If control circuitry determines, at 608, that the position of the object is within the portion of the face of the user, control circuitry may proceed to 612. In some embodiments, at 612, control circuitry provides, based on the virtual tutorial, second feedback to the user indicative of correct positioning of the object. In some implementations, at 614, control circuitry applies an AR visual effect to a portion of the video comprising the face of the user based at least in part on the position of the object.

FIG. 7 is a sequence diagram of a detailed illustrative process for applying virtual makeup in a digital environment based on IR data, in accordance with some embodiments of this disclosure. In various embodiments, the individual steps of process 700 may be implemented by one or more components of the devices, methods, and systems of FIG. 1 and FIGS. 3-4, and may be performed in combination with any of the other processes and aspects described herein. Although the present disclosure may describe certain steps of process 700 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, and FIGS. 5-6, and FIGS. 8-23 may implement those steps instead.

In some embodiments, a virtual makeup application system (e.g., system 706) enables users to apply makeup in a digital environment by combining IR depth-sensing technology with stylus-based sensors to achieve precise 3D tracking and interaction. System 706 may comprise IR depth sensing hardware 702 (e.g., Apple Face ID®, which projects a structured IR light pattern onto the user's face). In some embodiments, at 714, IR depth-sensing hardware 702 projects an IR light pattern onto a face of user 701 and stylus 704. User 701 may be holding stylus 704 in their hand near their face. In some implementations, at 716, stylus 704 reflects IR light towards IR depth-sensing hardware 702. At 718, user 701 reflects IR light towards IR depth-sensing hardware 702. In some embodiments, at 720, system 706 receives IR reflections captured by IR depth sensing hardware 702. In some implementations, at 722, system 706 compares live IR data to baseline facial profile. The baseline profile, generated during an initial calibration, includes reference points for key facial features (e.g., eyes, nose, lips), stored as a set of X, Y, and Z coordinates in the device's (e.g., the device running system 706) memory. Each reference point may have a corresponding set of IR grid points that form a “known reflection pattern.”

At 724, system 706 may calculate deviations in X (horizontal), Y (vertical), and Z (depth) from the baseline, expected IR return pattern. The displacement of any reference point may be calculated as Δd=√((Xₗᵢᵥₑ−X_bₐₛₑₗᵢₙₑ)²+(Yₗᵢᵥₑ−Y_bₐₛₑₗᵢₙₑ)²+(Zₗᵢᵥₑ−Z_bₐₛₑₗᵢₙₑ)²). In some embodiments, system 706 uses these displacements Ad to recalibrate the position of stylus 704 relative to the face in real time. Small adjustments in position and angle are made continuously, allowing system 706 to maintain accurate stylus 704 positioning even if the user's face shifts slightly. At 726, system 706 may calculate an angle between stylus 704 and the face of user 701. If ΔX, ΔY, and ΔZ represent the positional changes observed at each grid point relative to the baseline facial profile, then the angle θ between stylus 704 and the face can be calculated as θ=tan⁻¹ (√(ΔX²+ΔY²)/ΔZ ). This calculation enables system 706 to determine the tilt angle of stylus 704 relative to the user's face. At 728, system 706 may update the angle dynamically as stylus 704 moves, providing dynamic feedback on angle changes.

At 730, system 706 may detect proximity of stylus 704 based on reflection intensity and spread. As the stylus moves closer, the IR reflections become more concentrated and intense. System 706 may map these changes in reflection density and intensity onto a distance scale, providing an estimate of the stylus's depth (Z) relative to the baseline facial profile. At 732, system 706 may map reflection density to depth scale. At 734, system 706 may compare live IR data to baseline for positional recalibration. At 736, system 706 may calculate displacement for each facial landmark and/or deformity. At 738, system 706 may apply real-time adjustments to stylus 704 position. In some embodiments, at 740, system 706 applies a smoothing algorithm, such as Kalman filtering, for tracking stability. At 742, processor 708 may refine stylus 704 path and reduce noise by predicting likely movements based on recent data. Processor 708 may use the deviations detected from the baseline to refine the stylus's calculated path, enhancing the consistency and accuracy of tracking.

At 744, processor 708 may apply recursive updates to stabilize stylus 704's position. By applying recursive updates, processor 708 minimizes sudden jumps or drift in the stylus's perceived position, ensuring that stylus 704 remains aligned with the intended facial area. In some implementations, at 746, stylus 704 transmits tilt, roll, yaw, and pressure data to system 706. Tilt (α), roll (β), and yaw (γ) values may be transmitted by stylus 704 as angular data, calculated using accelerometer and gyroscope inputs within stylus 704. At 748, system 706 may calculate tilt, roll, yaw, and pressure based on the stylus sensor data. For tilt, α=sin⁻¹(Accel_Y/√(Accel_X²+Accel_Y²+Accel_Z²)), and for roll, β=sin⁻¹(Accel_X/√(Accel_X²+Accel Y²+Accel_Z²). The yaw angle γ may be derived from the gyroscope measurements as γ=tan⁻¹(Gyro_Y/Gyro_X). At 750, system 706 may integrate tilt, roll, yaw, and pressure for virtual effects. In some implementations, pressure data from the stylus tip provides additional control over makeup effects, as higher pressure may increase opacity or thickness in the application.

System 706 may combine pressure data with the IR-derived positional data to apply virtual effects like blending, layering, and shading that vary based on the stylus's orientation and proximity to the face. For example, if the tilt angle a indicates a steep angle with higher pressure, system 706 may interpret this as an application similar to pressing a makeup brush against the skin, resulting in a dense, opaque layer of virtual makeup. Conversely, a shallow angle with low pressure may create a softer effect, simulating a lighter touch with a brush. In some embodiments, at 752, system 706 applies effects to virtual makeup layer 754 based on the stylus data. At 754, system 706 may render virtual makeup layer 754 with variable blending, layering, and shading.

FIG. 8 is a sequence diagram of a detailed illustrative process for adjusting virtual makeup effects based on stylus data and the type of virtual makeup, in accordance with some embodiments of this disclosure. In various embodiments, the individual steps of process 800 may be implemented by one or more components of the devices, methods, and systems of FIG. 1 and FIGS. 3-4, and may be performed in combination with any of the other processes and aspects described herein. Although the present disclosure may describe certain steps of process 800 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-7, and FIGS. 9-23 may implement those steps instead.

In some embodiments, at 814, system 804 receives a selection from user 802 of a virtual makeup material (e.g., eyeliner, blush). In some implementations, system 804 adjusts virtual makeup effect 808 in real time by interpreting the stylus's pressure sensitivity in conjunction with the type of virtual makeup material selected, such as eyeliner, rouge, or foundation. The stylus's pressure sensors may detect variations in the force exerted by the user, and system 804 may translate this data to control the opacity, thickness, and spread of virtual makeup effect 808 in a way that matches the characteristics of the selected makeup material. Each virtual material may have predefined parameters, including default opacity, texture, and spread characteristics, which influence how pressure data from the stylus is interpreted. For example, foundation or concealer may have high opacity by default and respond to pressure by adjusting coverage and blend smoothness, while eyeshadow might include color blending effects for softer transitions between applied areas.

In some implementations, at 816, system 804 activates pressure sensitivity of stylus 806. In some embodiments, at 818, stylus 806 transmits pressure data to system 804 based on the force from user 802. In some implementations, at 820, system 804 interprets the pressure data according to the selected makeup material. At 822, system 804 may adjust opacity, thickness, and spread based on pressure and material type. In some embodiments, if the selected makeup material is eyeliner, at 824, system 804 increases line thickness and opacity of virtual makeup effect 808 with higher pressure. At 826, system 804 may decrease thickness and opacity of virtual makeup effect 808 with lighter pressure for a natural look. In some implementations, if the selected makeup material is blush, at 828, system 804 increases application area and opacity of virtual makeup effect 808 with higher pressure. At 830, system 804 may minimize spread and opacity of virtual makeup effect 808 with lighter pressure for subtle tint.

In some embodiments, at 832, system 804 applies predetermined parameters for each makeup type (opacity texture, spread). In some implementations, at 834, system 804 integrates stylus pressure with material properties. In some embodiments, processor 810 dynamically integrates stylus pressure input with these parameters to produce realistic effects, simulating the textures and coverage levels specific to each makeup material. Processor 810 may be integrated into the same device running system 804. At 836, processor 810 may render realistic texture and coverage of virtual makeup effect 808 based on stylus data. When the user selects a material such as rouge or blush, system 804 may adjust the application effect to match the softer, more diffuse properties of these products. In some embodiments, with increased pressure, system 804 expands the area of application and increases opacity to simulate a dense, full-coverage blush, as would result from pressing a makeup sponge or brush firmly against the skin. With lighter pressure, system 804 may minimize the spread and opacity, creating a lighter application that resembles a delicate dusting of blush or a subtle tint. In some embodiments, at 838, system 804 shows adjusted virtual makeup effect 808 with appropriate blending, thickness, and opacity at display 812.

FIG. 9 is a sequence diagram of a detailed illustrative process for applying virtual makeup based on stylus data, in accordance with some embodiments of this disclosure. In various embodiments, the individual steps of process 900 may be implemented by one or more components of the devices, methods, and systems of FIG. 1 and FIGS. 3-4, and may be performed in combination with any of the other processes and aspects described herein. Although the present disclosure may describe certain steps of process 900 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-8, and FIGS. 10-23 may implement those steps instead.

In some embodiments, at 910, stylus 902 is used to detect and transmit tilt, roll, and yaw data to system 904. In some embodiments, stylus 902 is operated by a user. In some embodiments, stylus 902 is operated by a robotic arm to apply virtual makeup to the user, e.g., I a store or a showroom. In some implementations, system 904 captures stylus orientation in real time. By capturing the stylus's orientation in real time, system 904 may adjust the virtual brushstroke width, texture, and application style to closely simulate the effects achieved with physical makeup tools. This functionality is particularly beneficial for techniques such as contouring, fine detail work around the eyes, and nuanced application of blush or foundation. In some embodiments, at 914, system 904 calculates brushstroke width, texture, and application style based on tilt. System 904 may calculate the tilt angle using real-time accelerometer data from stylus 902 and adjust the brushstroke parameters accordingly, ensuring smooth transitions between wide and narrow strokes as the user changes the angle of stylus 902. In some implementations, at 916, if system 904 determines a high tilt angle, system 904 widens and softens the brushstroke for diffused application of virtual makeup effect 906.

In some embodiments, at 918, if system 904 determines a low tilt angle, system 904 narrows and concentrates the brushstroke for detailed application of virtual makeup effect 906. In some implementations, at 920, system 904 adjusts stroke quality based on roll (rotation along its longitudinal axis) to further customize the shape and style of the application. In some embodiments, at 922, system 904 creates sharper lines of virtual makeup effect 906 with controlled roll. In some implementations, at 924, if stylus 902 is rotated for edge quality, system 904 creates softer edges of virtual makeup effect 906 with reduced roll. System 904 may compute the roll angle continuously based on gyroscope data within stylus 902, allowing for responsive adjustments that adapt to changes in stylus rotation. In some embodiments, at 926, system 904 modifies application orientation based on yaw (rotation relative to the user's face). In some implementations, if stylus 902 is horizontally rotated (yaw), at 928, system 904 adjusts shading direction for contouring or shadow effects of virtual makeup effect 906. In some embodiments, at 930, system 904 renders adjusted makeup effect with real-time orientation adjustments at display 908.

FIG. 10 is a sequence diagram of a detailed illustrative process for using facial feature data to enhance stylus tracking accuracy, in accordance with some embodiments of this disclosure. In various embodiments, the individual steps of process 1000 may be implemented by one or more components of the devices, methods, and systems of FIG. 1 and FIGS. 3-4, and may be performed in combination with any of the other processes and aspects described herein. Although the present disclosure may describe certain steps of process 1000 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-9, and FIGS. 11-23 may implement those steps instead.

In some embodiments, the IR depth-sensing system uses facial feature landmarks as stable reference points to enhance the tracking accuracy of the stylus's position near specific facial regions, such as the eyes, lips, and cheeks. In some embodiments, at 1010, system 1002 projects structured IR light pattern onto the face of user 1004. During an initial calibration phase, at 1012, system 1002 captures IR reflections from user 1004 and creates a baseline facial profile. At 1014, system 1002 may record key facial landmarks (eyes, nose, lips, cheeks) as X, Y, Z coordinates, forming a reference framework that enables system 1002 to track changes in the stylus's position relative to these fixed points. At 1016, system 1002 may store the facial profile with reference landmark positions. In some implementations, at 1018, system 1002 performs real-time tracking. At 1020, system 1002 captures live IR reflections from the face of user 1004. At 1022, system 1002 compares the live data with the baseline facial profile. At 1024, system 1002 calculates displacement for each landmark based on differences in X, Y, Z coordinates.

The displacement vector for each landmark may be computed as Δd=√((X_live−X_baseline)²+(Y_live−Y_baseline)²+(Z_live-Z_baseline)²), where X, Y, and Z represent the spatial coordinates of each landmark. System 1002 may use these displacement vectors to correct for small head movements and maintain alignment between the stylus and the facial landmarks, ensuring that virtual makeup effect 1006 is applied precisely where intended. For example, if user 1004 shifts slightly, system 1002 may adjust the stylus's position relative to the facial profile to prevent drift, ensuring that virtual eyeliner remains correctly aligned with the eye or that virtual blush remains accurately positioned on the cheeks. At 1028, system 1002 recalibrates stylus position relative to facial landmarks. In some embodiments, at 1030, system 1002 detects small head movements from user 1004. At 1032, system 1002 dynamically adjusts stylus position to maintain alignment with the facial profile. At 1034, system 1002 updates the position of virtual makeup effect 1006 based on the recalibrated stylus position. At 1036, system 1002 renders virtual makeup effect 1006 precisely aligned with the facial landmarks at display 1008.

FIG. 11 is a sequence diagram of a detailed illustrative process for adjusting makeup effects based on stylus gestures, in accordance with some embodiments of this disclosure. In various embodiments, the individual steps of process 1100 may be implemented by one or more components of the devices, methods, and systems of FIG. 1 and FIGS. 3-4, and may be performed in combination with any of the other processes and aspects described herein. Although the present disclosure may describe certain steps of process 1100 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIG. 5, and FIGS. 12-23 may implement those steps instead.

In some embodiments, system 1104 adjusts makeup effects based on specific stylus gestures, such as tapping, sweeping, zigzagging, or pressing, to simulate different makeup techniques like stippling, blending, or shading. In some embodiments, at 1110, stylus 1102 detects a stylus gesture (e.g., tapping, sweeping, pressing). At 1112, system 1104 interprets gesture type and intensity. In some embodiments, at 1114, system 1104 interprets the gesture as tapping. At 1116, system 1104 applies a soft, stippled effect to virtual makeup effect 1106 (e.g., powder or blush). In some implementations, at 1118, system 1104 interprets the gesture as sweeping. At 1120, system 1104 creates a blended effect for virtual makeup effect 1106 for smooth application (e.g., eyeshadow or contouring). In some embodiments, at 1124, system 1104 interprets the gesture as pressing. At 1126, system 1126 increases coverage and intensity of virtual makeup effect 1106, simulating deeper color or denser application. At 1130, system 1104 renders virtual makeup effect 1106 at display 1108 based on stylus gesture in real time.

FIG. 12 is a sequence diagram of a detailed illustrative process for adjusting virtual makeup application based on stylus proximity to the face of a user, in accordance with some embodiments of this disclosure. In various embodiments, the individual steps of process 1200 may be implemented by one or more components of the devices, methods, and systems of FIG. 1 and FIGS. 3-4, and may be performed in combination with any of the other processes and aspects described herein. Although the present disclosure may describe certain steps of process 1200 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-11, and FIGS. 13-23 may implement those steps instead.

In some embodiments, system 1204 calibrates IR depth-sensing input by analyzing changes in the reflected IR patterns from stylus 1206 as it moves closer to or farther from the face, allowing for precise proximity detection for accurate makeup application. In some embodiments, at 1212, IR depth sensing hardware 1202 projects an IR light grid onto the face of a user using a device running system 1204, creating a stable pattern of reflected light points in the absence of the stylus. At 1214, system 1204 captures baseline IR reflection pattern (intensity and distribution). In some implementations, at 1216, system 1204 detects the proximity of stylus 1206 to the face of the user. At 1218, stylus 1206 reflects IR light as stylus 1206 approaches the face. At 1220, IR depth sensing hardware captures a disrupted IR light reflection pattern from stylus 1206.

At 1222, system 1204 measures intensity and spatial spread of reflected IR signals. At 1224, system 1204 calculates stylus distance based on intensity and distribution changes. System 1204 may calculate the distance (d) of stylus 1206 based on the inverse relationship between intensity and distance (as intensity increases, distance decreases). If (I₀) represents the baseline intensity of IR reflections from the face alone, and (Iₛ) represents the intensity when stylus 1206 is present, the distance (d) may be approximated by: d≈1/√(Iₛ−I₀). Here, a higher (Iₛ) indicates that stylus 1206 is closer to the face. In addition to intensity, system 1204 may assess changes in the spatial distribution of the IR points. As stylus 1206 moves closer, the IR points around it become more concentrated, indicating a convergence in the reflected IR grid.

By continuously measuring this shift in point density, system 1204 may refine its depth calculations for the stylus's position relative to the face with millimeter-level precision. This sensitivity enables system 1204 to detect subtle proximity changes, which are especially useful when stylus 1206 is near delicate facial areas like the eyelids or cheekbones, where precise virtual makeup application is critical. In some embodiments, at 1226, stylus 1206 moves closer to the face. At 1228, system 1204 detects increased intensity and denser IR point clustering. At 1230, system 1204 increases opacity and spread of virtual makeup effect 1208 for saturated application. In some implementations, at 1232, stylus 1206 moves farther from the face. At 1234, system 1204 detects decreased intensity and reduced IR point clustering. At 1236, system 1204 decreases opacity and spread of virtual makeup effect 1208 for softer, lighter application. At 1238, system 1204 renders virtual makeup effect 1208 with distance-based adjustments in real time.

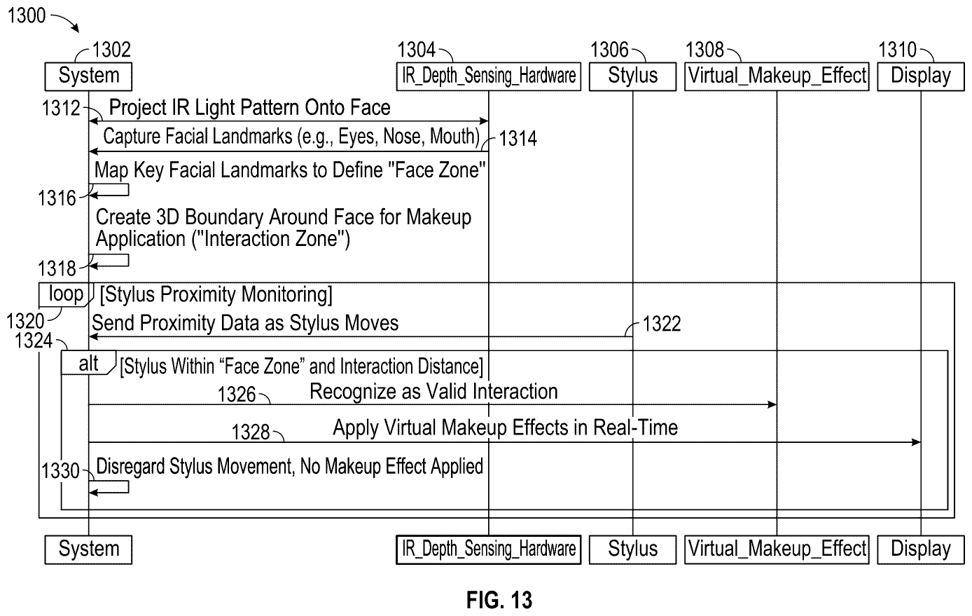

FIG. 13 is a sequence diagram of a detailed illustrative process for distinguishing between interactions of a stylus with a user's face and other objects within the camera's field of view, in accordance with some embodiments of this disclosure. In various embodiments, the individual steps of process 1300 may be implemented by one or more components of the devices, methods, and systems of FIG. 1 and FIGS. 3-4, and may be performed in combination with any of the other processes and aspects described herein. Although the present disclosure may describe certain steps of process 1300 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-12, and FIGS. 14-23 may implement those steps instead.

In some embodiments, at 1312, IR depth sensing hardware 1304 projects an IR light pattern onto the face of a user using a device integrated with system 1302. At 1314, system 1302 captures facial landmarks (e.g., eyes, nose, mouth). At 1316, systems 1302 maps key facial landmarks to define a “face zone.” At 1318, system 1302 creates a 3D boundary around the face for makeup application (“interaction zone”). In some implementations, at 1320, system 1302 performs stylus proximity monitoring. At 1322, stylus 1306 sends proximity data to system 1302 as stylus 1306 moves. In some embodiments, at 1324, stylus 1306 is within the “face zone” and interaction distance (e.g., a specified distance threshold). At 1326, system 1302 recognizes the stylus movement as a valid interaction. At 1328, system 1302 applies virtual makeup effect 1308 in real time to display 1310. In some implementations, when system 1302 does not recognize the stylus movement has a valid interaction due to stylus 1306 being outside the face zone, system 1330 disregards stylus movement and no virtual makeup effect is applied.

FIG. 14 is a sequence diagram of a detailed illustrative process for providing a zoomed-in view of specific facial areas during application to enhance precision in areas requiring fine detail, in accordance with some embodiments of this disclosure. In various embodiments, the individual steps of process 1400 may be implemented by one or more components of the devices, methods, and systems of FIG. 1 and FIGS. 3-4, and may be performed in combination with any of the other processes and aspects described herein. Although the present disclosure may describe certain steps of process 1400 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-13, and FIGS. 15-23 may implement those steps instead.

In some embodiments, at 1410, IR depth sensing hardware 1404 projects an IR light pattern onto the face of a user. At 1412, IR depth sensing hardware 1404 captures facial landmarks (e.g., eyes, lips, brows). In some implementations, at 1414, system 1402 continually monitors stylus 1406 position relative to facial landmarks. At 1416, stylus 1406 sends position data relative to facial landmarks to system 1402. In some embodiments, at 1418, system 1402 determines that stylus 1406 is near a detail-sensitive area (e.g., eyelid, lips, brows). At 1420, system 1402 activates a zoomed-in view at display 1408 centered on stylus 1406 position. The system may activate a magnified overlay on the specific region (stylus 1406 position) of display 1408. By dynamically zooming in on the region where the stylus is active, the user gains a magnified view that allows for more controlled and refined application, especially beneficial for small, intricate areas of the face.

At 1422, system 1402 tracks stylus 1406 movements in real-time with zoomed view, ensuring that the magnified area follows stylus 1406 precisely as it moves along the selected facial feature. For example, as the user applies virtual eyeliner, system 1402 may provide a close-up of the lash line, making it easier to place and adjust fine lines with high accuracy. Similarly, when applying lip liner, system 1402 may zoom in on the lip contours, allowing for careful adjustments to shape and intensity. At 1424, system 1402 applies virtual makeup with enhanced precision at display 1408. In some embodiments, the zoom functionality remains active only while stylus 1406 is within the designated facial feature area, automatically reverting to a normal view when stylus 1406 moves away from these regions. At 1426, system 1402 reverts to normal view (no zoom) at display 1408.

FIG. 15 is a sequence diagram of a detailed illustrative process for providing a virtual makeup effect based on the type of virtual tool, in accordance with some embodiments of this disclosure. In various embodiments, the individual steps of process 1500 may be implemented by one or more components of the devices, methods, and systems of FIG. 1 and FIGS. 3-4, and may be performed in combination with any of the other processes and aspects described herein. Although the present disclosure may describe certain steps of process 1500 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-14, and FIGS. 16-23 may implement those steps instead.

In some embodiments, at 1508, user 1500 selects a virtual makeup tool (e.g., brush, sponge, pencil) for a physical tool, e.g., a stylus, to emulate. In some implementations, selecting a brush tool dynamically adjusts the stylus's sensitivity to pressure, tilt, and speed, enabling creation of nuanced effects such as soft, layered strokes or diffused edges. As pressure and speed change, system 1502 may dynamically modify texture and opacity to mimic the feathered effect of a real brush, where gentle strokes apply lighter, dispersed color, and increased pressure adds intensity with more blended edges. Also at 1508, system 1502 receives the user selection. In some implementations, at 1510, system 1502 determines that a brush tool was selected. In some embodiments, at 1512, system 1502 adjusts the stylus's response to pressure, tilt, and speed. In some implementations, at 1514, system 1502 applies soft, layered strokes with diffused edges to virtual makeup effect 1504. In some embodiments, at 1516, system 1502 modifies texture and opacity of virtual makeup effect 1504 based on stroke pressure and speed.

In some implementations, at 1518, system 1502 determines that a sponge tool was selected. In some embodiments, the stylus delivers a soft, cushioned vibration that mimics the feel of a makeup sponge pressing onto the skin. The haptic intensity may increase in correlation with pressure, creating a tactile response that feels progressively firmer as the user presses harder. Similarly, a foundation brush tool might produce a consistent, moderate vibration that increases as the stylus moves, replicating the sensation of spreading foundation evenly over the skin. In some embodiments, at 1520, system 1502 interprets stylus proximity, pressure, and sweeping motion. In some implementations, at 1522, system 1502 creates a smooth, even layer of virtual makeup effect 1504 across the application area. In some embodiments, at 1524, system 1502 diffuses color of virtual makeup effect 1504 evenly for blended, broad-based coverage.

In some implementations, at 1526, system 1502 determines that a pencil tool has been selected. In some embodiments, at 1530, system 1502 adjusts stylus responsiveness to angle and pressure to emphasize precision and detail in a way that replicates the sharpness and control of a real makeup pencil. In some implementations, at 1532, system 1502 provides precision strokes of virtual makeup effect 1504 with controlled taper and sharp edges. In some embodiments, at 1534, system 1502 applies fine detailing of virtual makeup effect 1504 for areas like lash line or lip contour. In some implementations, at 1536, system 1502 renders virtual makeup effect 1504 with characteristics of the selected tool in real time at display 1506.

FIG. 16 is a sequence diagram of a detailed illustrative process for layering virtual makeup effects, in accordance with some embodiments of this disclosure. In various embodiments, the individual steps of process 1600 may be implemented by one or more components of the devices, methods, and systems of FIG. 1 and FIGS. 3-4, and may be performed in combination with any of the other processes and aspects described herein. Although the present disclosure may describe certain steps of process 1600 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-15, and FIGS. 17-23 may implement those steps instead.

In some embodiments, system 1604 provides realistic layering effects, allowing users to build up virtual makeup by reapplying layers in the same area, similar to real-world techniques for foundation, eyeshadow, and blush. Each layer contributes to the overall opacity, intensity, and texture, enabling users to control the depth of coverage and color gradually. In some embodiments, at 1610, user 1602 applies virtual makeup with a stylus. In some implementations, at 1612, system 1604 determines that the stylus detected light pressure applied. In some embodiments, by leveraging the stylus's pressure sensors and IR tracking data, system 1604 dynamically determines the amount of blending and coverage based on the user's interactions. In some embodiments, at 1614, system 1604 adds a soft, translucent layer of virtual makeup effect 1606 with minimal opacity. This may be ideal for delicate applications, such as a sheer wash of eyeshadow or a light blush. In some implementations, at 1616, system 1604 renders a sheer wash effect of virtual makeup effect 1606 for delicate applications at display 1608.

In some embodiments, at 1618, system 1604 detects that the stylus is being used to apply heavy pressure. In some implementations, at 1620, system 1604 increases opacity and coverage of virtual makeup effect 1606 for denser application. In some embodiments, at 1622, system 604 renders a bolder effect of virtual makeup effect 1606 for foundation or intense color. In some implementations, each increase in pressure adds a “layering effect,” amplifying color and opacity with each pass to allow for buildable application.

In some implementations, at 1624, system 1604 detects layering by detecting multiple passes of the stylus or circular motion of the stylus using IR track data. In some embodiments, when the stylus makes repetitive circular motions, system 1604 detects blending. In some implementations, at 1628, system 1604 increases blending intensity of virtual makeup effect 1606 for smooth transitions. In some embodiments, at 1630, system 1604 renders a smooth, even effect of virtual makeup effect 1606 to integrate colors seamlessly, simulating a makeup brush's ability to smooth out edges. In some implementations, at 1632, system 1604 renders a final layered effect based on stylus pressure and movement. This real-time adjustment enables system 1604 to respond accurately to both the intensity and the motion of the stylus, replicating the control needed to create natural gradients and transitions.

FIG. 17 is a sequence diagram of a detailed illustrative process for adjusting virtual makeup application based on stylus sensor data, in accordance with some embodiments of this disclosure. In various embodiments, the individual steps of process 1700 may be implemented by one or more components of the devices, methods, and systems of FIG. 1 and FIGS. 3-4, and may be performed in combination with any of the other processes and aspects described herein. Although the present disclosure may describe certain steps of process 1700 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-16, and FIGS. 18-23 may implement those steps instead.

In some embodiments, at 1712, user 1702 holds stylus 1704 for makeup application. In some implementations, at 1714, system 1706 detects finger positions on stylus 1704 with integrated sensors. The integrated sensors may enable system 1706 to adjust virtual makeup effects based on the user's grip, providing more nuanced control over application techniques. By detecting specific finger placements, system 1706 can infer the user's intended approach, such as whether they are holding stylus 1704 for detailed work or broader strokes, and adjust virtual tool behavior accordingly. In some embodiments, at 1716, system 1706 detects a precision grip (e.g., fingers of user 1702 are near the tip of stylus 1704). In some implementations, at 1718, system 1704 adjusts virtual makeup effect 1708 for detailed work (e.g., narrow strokes, increased opacity). In some embodiments, at 1720, system 1706 renders precise, controlled application of virtual makeup effect 1708 (e.g., eyeliner, lip liner) at display 1710.

In some implementations, at 1722, system 1706 detects a broad grip (e.g., fingers of user 1702 are farther from the tip of stylus 1704). In some embodiments, at 1724, system 1706 adjusts virtual makeup effect 1708 for broader strokes (e.g., wider, softer strokes). In some implementations, at 1726, system 1706 renders soft, blended effect of virtual makeup effect 1708 (e.g., blush, foundation) at display 1710. At 1728, system 1706 updates virtual makeup effect 1708 based on grip data of stylus 1704 in real time.

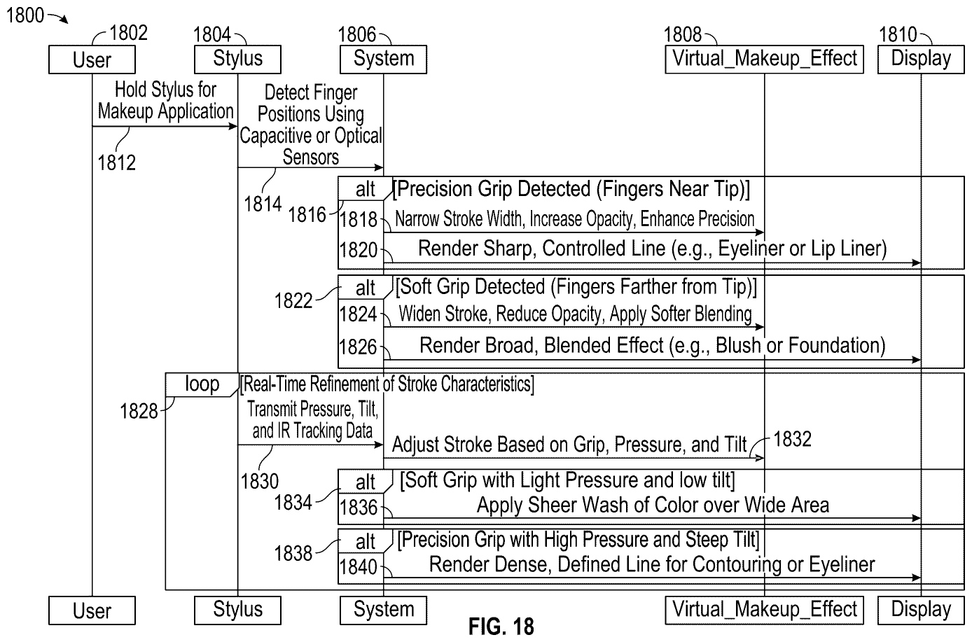

FIG. 18 is a sequence diagram of a detailed illustrative process for adapting a virtual makeup application based on stylus sensor data, in accordance with some embodiments of this disclosure. In various embodiments, the individual steps of process 1800 may be implemented by one or more components of the devices, methods, and systems of FIG. 1 and FIGS. 3-4, and may be performed in combination with any of the other processes and aspects described herein. Although the present disclosure may describe certain steps of process 1800 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIG. 5, and FIGS. 7-8 may implement those steps instead.

In some embodiments, at 1812, user 1802 holds stylus 1804 for makeup application. The stylus may be equipped with capacitive or optical sensors along its shaft that can register contact points when fingers touch specific areas. At 1814, system 1806 detects finger positions on stylus 1804 using capacitive or optical sensors. In some embodiments, at 1816, system 1806 detects a precision grip (e.g., fingers of user 1802 are near the tip of stylus 1804). A precision grip may be used for detail work like applying eyeliner or defining lip edges. At 1818, system 1806 adjusts virtual makeup effect 1808 to have a narrow stroke width, increase opacity, and enhance precision, emulating the effect of using a fine-tip makeup brush or pencil for sharp, controlled lines. At 1820, system 1806 renders virtual makeup effect 1808 as a sharp, controlled line (e.g., eyeliner or lip liner) at display 1810.

In some embodiments, at 1822, system 1806 detects a soft grip (e.g., fingers of user 1802 are farther from the tip of stylus 1804). The soft grip may be used for tasks like applying blush or foundation. At 1824, system 1806 adjusts virtual makeup effect 1808 to have a wider stroke, reduce opacity, and apply softer blending, simulating the effect of a large, fluffy makeup brush. At 1826, system 1806 renders virtual makeup effect 1808 with a broad, blended effect (e.g., blush or foundation).

In some embodiments, at 1828, system 1806 performs real-time refinement of stroke characteristics. This adaptability allows system 1806 to shift seamlessly between detailed and general application styles based on finger positioning, without requiring the user to adjust settings manually. System 1806 may continuously analyze input from the finger detection sensors. At 1830, stylus 1804 transmits pressure, tilt, and IR tracking data to system 1806. At 1832, system 1806 adjusts stroke of virtual makeup effect 1808 based on grip, pressure, and tilt. At 1834, system 1806 detects soft grip with light pressure and low tilt. At 1836, system 1806 applies virtual makeup effect 1808 as a sheer wash of color over a wide area at display 1810. In some implementations, at 1838, system 1805 detects precision grip with high pressure and steep tilt. At 1840, system 1805 renders virtual makeup effect 1808 as a dense, defined line for contouring or eyeliner at display 1810.

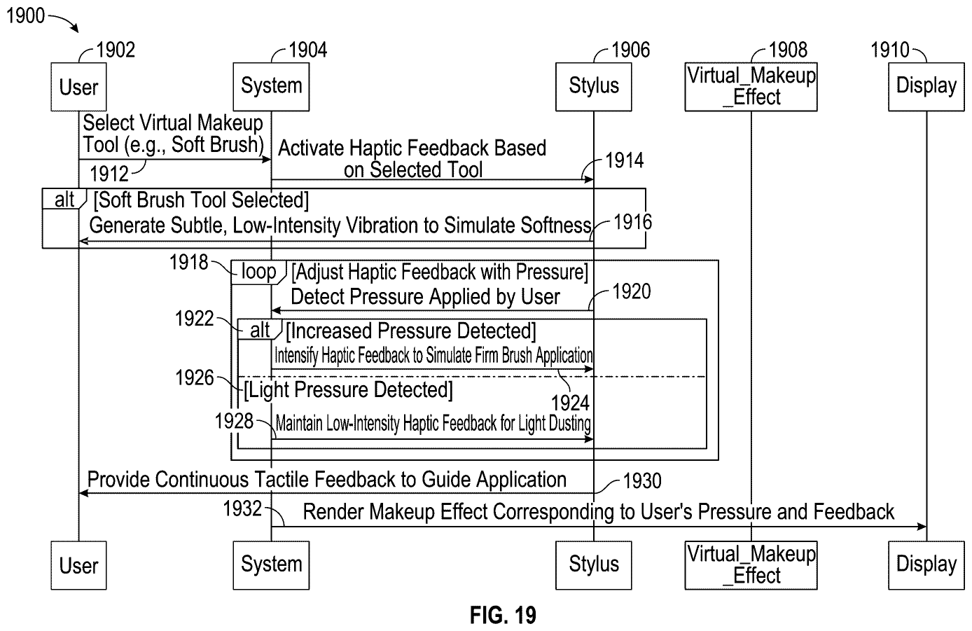

FIG. 19 is a sequence diagram of a detailed illustrative process for providing haptic feedback based on a type of virtual tool, in accordance with some embodiments of this disclosure. In various embodiments, the individual steps of process 1900 may be implemented by one or more components of the devices, methods, and systems of FIG. 1 and FIGS. 3-4, and may be performed in combination with any of the other processes and aspects described herein. Although the present disclosure may describe certain steps of process 1900 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-18, and FIGS. 20-23 may implement those steps instead.

In some embodiments, stylus 1930 incorporates haptic feedback, providing users with tactile sensations that simulate the feel of different makeup tools, textures, and application pressures. This haptic feedback allows users to experience varying levels of resistance, vibration, or pulse based on the virtual tool selected, further enhancing the realism and control of the virtual makeup application process. For example, at 1912, system 1904 receives a selection from user 1902 of a virtual makeup tool (e.g., soft brush). At 1914, system 1904 activates haptic feedback at stylus 1906 based on the selected tool. At 1916, stylus 1906 generates subtle, low-intensity vibration to simulate softness and light resistance of a makeup brush for user 1902 to feel. At 1918, system 1904 adjusts haptic feedback with pressure. At 1920, system 1904 detects pressure applied by user 1902 to stylus 1906.

In some embodiments, at 1922, system 1904 determines that an increase in the pressure was detected. At 1924, system 1904 intensifies the haptic feedback at stylus 1906 to simulate firm brush application. In some embodiments, at 1926, system 1904 determines that light pressure was detected. At 1928, system 1904 maintains low-intensity haptic feedback at stylus 1906 for light dusting. This feedback may guide users as they apply layers of virtual makeup, indicating when they are applying the right amount of pressure for their desired effect. At 1930, stylus 1930 provides continuous tactile feedback to user 1902 via stylus 1906 to guide application of the virtual makeup. At 1932, system 1904 renders virtual makeup effect 1908, corresponding to user 1902's pressure and feedback, at display 1910.

FIG. 20 is a sequence diagram of a detailed illustrative process for providing haptic feedback based on a type of virtual tool, in accordance with some embodiments of this disclosure. In various embodiments, the individual steps of process 2000 may be implemented by one or more components of the devices, methods, and systems of FIG. 1 and FIGS. 3-4, and may be performed in combination with any of the other processes and aspects described herein. Although the present disclosure may describe certain steps of process 2000 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-19, and FIGS. 21-23 may implement those steps instead.

In some embodiments, stylus 2006 provides sharper, more distinct feedback when using virtual tools that require precision, such as an eyeliner pencil or lip liner. At 2012, system 2004 receives a selection from user 2002 of a precision tool (e.g., eyeliner pencil or lip liner). At 2014, system 2004 activates high-frequency, focused haptic feedback that replicates the firm contact of a pencil against the skin at stylus 2006 for precision. This effect may be useful for detail work, as the haptic feedback offers a steady tactile cue to maintain control during fine applications. At 2016, stylus 2006 provides steady, distinct feedback to simulate firm contact for user 2002. In some embodiments, at 2018, stylus 2006 transmits roll and tilt data to system 2004 in real time. At 2020, system 2004 adjusts the haptic feedback intensity and frequency at stylus 2006 based on stylus orientation. In some implementations, at 2022, based on detecting increased tilt or roll, stylus 2006 adjusts feedback to mirror changes in stroke width or intensity. In some embodiments, at 2024, based on detecting reduced tilt or roll, stylus 2006 maintains focused, steady feedback for precise application. At 2026, system 2004 renders virtual makeup effect 2008 at display 2010 with adjustments based on orientation of stylus 2006.

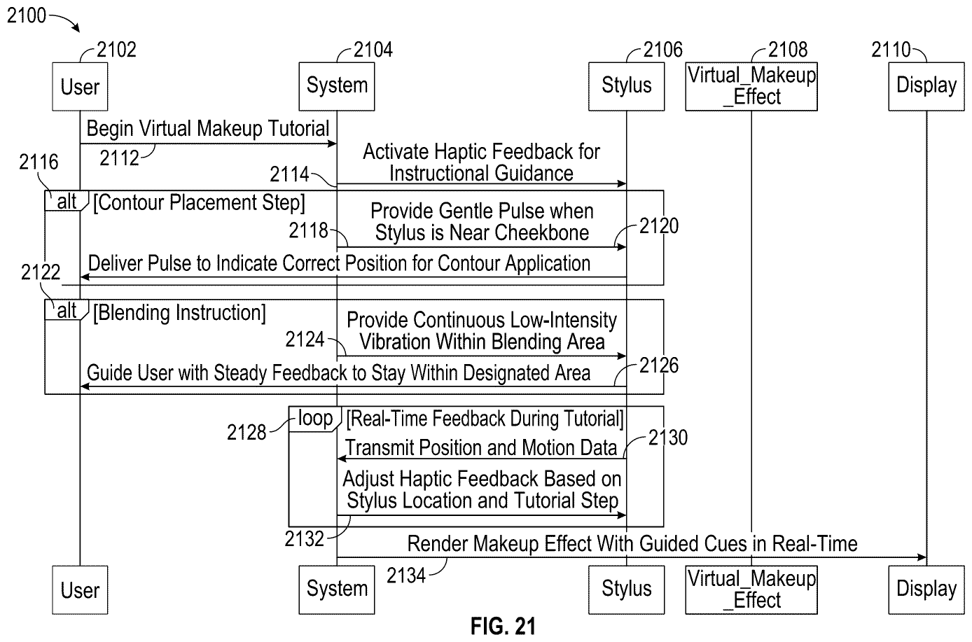

FIG. 21 is a sequence diagram of a detailed illustrative process for using haptic feedback to guide users during virtual makeup tutorials, in accordance with some embodiments of this disclosure. In various embodiments, the individual steps of process 2100 may be implemented by one or more components of the devices, methods, and systems of FIG. 1 and FIGS. 3-4, and may be performed in combination with any of the other processes and aspects described herein. Although the present disclosure may describe certain steps of process 2100 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-20, and FIGS. 22-23 may implement those steps instead.

In some embodiments, system 2104 uses haptic feedback to guide users during virtual makeup tutorials or instructional modes. At 2112, user 2102 begins a virtual makeup tutorial via system 2104. At 2114, system 2104 activates haptic feedback for instructional guidance at stylus 2106. In some implementations, at 2116, the virtual makeup tutorial provides a contour placement step. When following a guided application technique, stylus 2106 provides gentle pulses to indicate the correct placement or motion for specific makeup steps. At 2118, system 2118 provides a gentle pulse to stylus 2106 when stylus 2106 is near a cheekbone of user 2102. At 2120, stylus 2106 delivers the pulse to user 2102 to indicate correct position for contour application. In some embodiments, at 2122, the virtual makeup tutorial provides a blending instruction. At 2124, system 2104 provides continuous low-intensity vibration to stylus 2106 within the blending area. At 2126, stylus 2126 guides user 2102 with steady feedback to stay within the designated area.

In some embodiments, at 2128, system 2104 provides real-time feedback (e.g., sensory cues) during the virtual makeup tutorial. In some embodiments, system 2104 may save the input data that is used to apply the virtual makeup, for example, data generated by stylus 2106 such as inertial measurement unit (IMU) data, as well as data based on the detected face region via the IR sensors. This data may be referenced in later sessions to allow a user to reproduce the effect they achieved during a previous session. At 2130, stylus 2130 transmits position and motion data to system 2104. At 2132, system 2104 adjusts haptic feedback of stylus 2106 based on stylus 2106 location and tutorial step. At 2134, system 2104 renders virtual makeup effect 2108 at display 2110 with guided cues in real time.

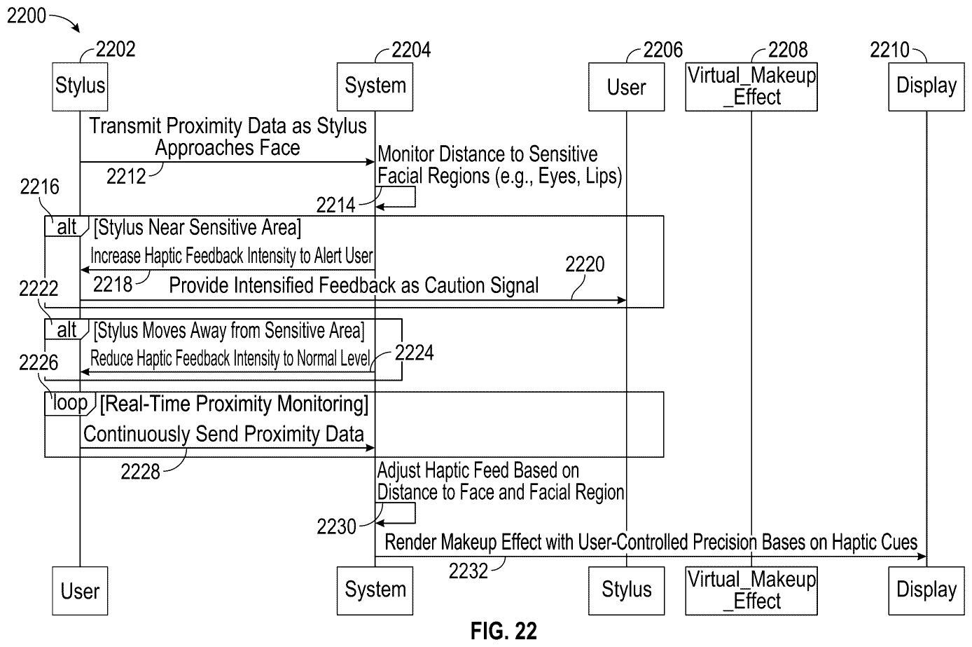

FIG. 22 is a sequence diagram of a detailed illustrative process for leveraging haptic feedback to indicate proximity to facial regions, in accordance with some embodiments of this disclosure. In various embodiments, the individual steps of process 2200 may be implemented by one or more components of the devices, methods, and systems of FIG. 1 and FIGS. 3-4, and may be performed in combination with any of the other processes and aspects described herein. Although the present disclosure may describe certain steps of process 2200 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, FIGS. 5-21, and FIG. 23 may implement those steps instead.

In some embodiments, at 2212, stylus 2202 transmits proximity data to system 2204 as stylus 2202 approaches the face of user 2206. In some embodiments, system 2204 leverages haptic feedback to indicate proximity to the face or designated facial regions. At 2214, system 2204 monitors the distance of stylus 2202 to sensitive facial regions (e.g., eyes, lips) of user 2206. In some embodiments, at 2216, system 2204 determines that stylus 2202 is near a sensitive area. At 2218, system 2204 increases haptic feedback intensity of stylus 2202 to alert user 2206 to be cautious or slow their movements. At 2220, stylus 2202 provides intensified feedback as a caution signal to user 2206.

In some implementations, at 2222, system 2204 determines that stylus 2202 moves away from the sensitive area. At 2224, system 2204 reduces haptic feedback intensity of stylus 2202 to a normal level. In some implementations, at 2226, system 2204 provides real-time proximity monitoring. At 2228, stylus 2202 continuously sends proximity data to system 2204. At 2230, system 2204 adjusts haptic feedback based on distance of stylus 2202 to the face and facial region of user 2206. At 2232, system 2204 renders virtual makeup effect 2208 with user-controlled precision based on haptic cues at display 2210. System 2204 may enhance precision, particularly in detail-heavy areas, by providing users with a non-visual cue to control their motions.

FIG. 23 is a sequence diagram of a detailed illustrative process for tracking a stylus based on IR reflections, in accordance with some embodiments of this disclosure. In various embodiments, the individual steps of process 2300 may be implemented by one or more components of the devices, methods, and systems of FIG. 1 and FIGS. 3-4, and may be performed in combination with any of the other processes and aspects described herein. Although the present disclosure may describe certain steps of process 2300 (and of other processes described herein) as being implemented by certain components of the devices, methods, and systems of FIG. 1 and FIGS. 3-4, this is for purposes of illustration only, and it should be understood that other components of the devices, methods, and systems of FIG. 2, and FIGS. 5-22 may implement those steps instead.

In some embodiments, at 2312, IR sensor 2302 captures IR reflections and depth data. At 2314, image processor 2304 segments stylus reflections. In some implementations, the IR reflections and depth data captured by IR sensor 2302 are impacted by ambient light in the room/environment. Image processor 2304 may use bandpass filters to prevent or allow specific wavelengths to reduce the impact of visible light, any other suitable light source, or any suitable combination thereof. For example, if the user is trying to achieve a “night time” makeup look, image processor 2304 may adjust the settings of IR sensor 2302 to best reflect night time lighting. In some embodiments, the stylus may be comprised of reflective elements that are designed to reflect the IR light in a normalized manner. In some implementations, the stylus may be injection-molded. For example, if the stylus is hexagonal (e.g., a hexagonal cross section), each side may include reflective materials that reflect IR light at a specific angle or in a certain manner. This may enable a stylus to be tracked without the use of embedded electronics. At 2316, image processor 2304 extracts reflection features and sends them to tracking algorithm 2308. At 2318, tracking algorithm 2308 matches the extracted reflection features to pre-calibrated patterns in pattern database 2306. A user may need to select their stylus “model number” from a list of pre-calibrated styluses (e.g., pattern database 2306).

In some embodiments, to enable this tracking without embedded electronics, the stylus may rely entirely on the passive interaction between the IR light and its reflective surfaces. For example, each side of the stylus may have a specific shape, such as flat, curved, or angled, combined with material coatings of differing IR reflectivity. These physical properties may create distinct reflection signatures that a system may interpret using image processing algorithms or techniques. At 2320, pattern database 2306 returns a matching pattern and orientation to tracking algorithm 2308. In some embodiments, the system may use techniques such as pattern matching or machine learning to identify and interpret the unique reflective characteristics of each side of the stylus in real time. Based on the unique reflective properties of each stylus reflection pattern, tracking algorithm 2308 may distinguish one stylus from another. At 2322, tracking algorithm 2308 integrates depth data to determine stylus position.

In some implementations, by comparing the observed IR reflections against the pre-calibrated database (e.g., pattern database 2306) of reflection patterns for known orientations, the system may accurately estimate the stylus's position and orientation. This approach may be further refined by introducing reflective elements with structured patterns, such as grooves or micro textures, which may scatter IR light in predictable ways. At 2324, in some embodiments, tracking algorithm 2308 applies a Kalman filter for smoothing. At 2326, tracking algorithm 2308 sends stylus position and orientation data to output system 2310.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
obtaining a video, via a camera of a user device, comprising a user in an environment;
projecting infrared (IR) light onto the user in the environment;
detecting IR light reflection data corresponding to the projected IR light reflected by an object being held by the user in the environment;
comparing the IR light reflection data to baseline profile data of the user; and
based on the comparing: determining that a position of the object is within a threshold proximity of the user and applying an extended reality (XR) visual effect to a portion of the video comprising the user.

2. The method of claim 1, wherein determining, based on the IR light reflection data, that the object is within the threshold proximity of the user comprises determining that the object is in contact with the user based on detecting a variation in an intensity and a distribution of IR light reflections of the IR light reflection data in relation to baseline IR light reflections indicated by the baseline profile data.

3. The method of claim 1, wherein comparing the IR light reflection data to the baseline profile data comprises calculating a displacement between an IR light reflection pattern indicated by the IR light reflection data and a baseline IR light pattern indicated by the baseline profile data.

4. The method of claim 1, wherein the XR visual effect is an AR cosmetic effect on the user and the object is a cosmetic tool or a stylus that represents a cosmetic tool.

5. The method of claim 1, wherein the object is a stylus, the method further comprising:
receiving an input that indicates a selection of a type of tool, of a plurality of tools, for the stylus to emulate, wherein each tool of the plurality of tools is associated with one or more parameters indicating a manner of applying the XR visual effect for the respective tool, and wherein the one or more parameters is based at least in part on stylus pressure data obtained from a sensor of the stylus in relation to the user; and
applying the XR visual effect to the user based at least in part on the type of tool.

6. The method of claim 1, wherein the object is a stylus, and wherein the position of the stylus comprises data of at least one of an angle of the stylus relative to the user, a tilt of the stylus relative to the user, a yaw of the stylus relative to the user, or a roll of the stylus relative to the user.

7. The method of claim 6, wherein the angle of the stylus relative to the user, the tilt of the stylus relative to the user, the yaw of the stylus relative to the user, and the roll of the stylus relative to the user cause the AR visual effect to be modified.

8. The method of claim 1, wherein the XR visual effect is applied to a first portion of the video corresponding to a first portion of the user, the method further comprising:
detecting movement of the object within the threshold proximity to the user; and
applying the XR visual effect to a second portion of the video corresponding to a second portion of the user based at least in part on the movement of the object.

9. The method of claim 1, wherein the XR visual effect is applied to a portion of the video corresponding to a portion of the user, the method further comprising:
detecting movement of the object within the threshold proximity to the user; and
continually applying the XR visual effect to the portion of the video corresponding to the portion of the user based at least in part on the movement of the object, wherein the continually applying further comprises layering the XR visual effect to the portion of the video corresponding to the portion of the user.

10. The method of claim 1, wherein the threshold proximity is a first threshold proximity, the method further comprising:
detecting that the object is within a second threshold proximity of a particular region of the user; and
based on the detecting that the object is within the second threshold proximity of the particular region of the user, enlarging a portion of the video comprising the particular region of the user to cause the particular region of the user to appear larger in relation to other portions of the video.

11. The method of claim 1, further comprising:
determining, based on the IR light reflection data, a change in proximity between the object and the user; and
based at least in part on the change in the proximity, adjusting the XR visual effect applied to the video.

12. The method of claim 1, wherein the IR light is projected onto a face of the user in the environment.

13. The method of claim 1, wherein the IR light is projected by the user device.

14. The method of claim 1, wherein the comparing further comprises comparing the IR light reflection data to baseline object profile data of the object.

15. A system comprising:
input/output circuitry configured to:
obtain a video, via a camera of a user device, comprising a user in an environment;
project infrared (IR) light onto the user in the environment;
control circuitry configured to:
detect IR light reflection data corresponding to the projected IR light reflected by an object being held by the user in the environment;
compare the IR light reflection data to baseline profile data of the user; and
based on the comparing: determine that a position of the object is within a threshold proximity of the user and applying an extended reality (XR) visual effect to a portion of the video comprising the user.

16. The system of claim 15, wherein the control circuitry is further configured to determine, based on the IR light reflection data, that the object is within the threshold proximity of the user by determining that the object is in contact with the user based on detecting a variation in an intensity and a distribution of IR light reflections of the IR light reflection data in relation to baseline IR light reflections indicated by the baseline profile data.

17. The system of claim 15, wherein the control circuitry is further configured to compare the IR light reflection data to the baseline profile data by calculating a displacement between an IR light reflection pattern indicated by the IR light reflection data and a baseline IR light pattern indicated by the baseline profile data.

18. The system of claim 15, wherein the XR visual effect is an AR cosmetic effect on the user and the object is a cosmetic tool or a stylus that represents a cosmetic tool.

19. The system of claim 15, wherein the object is a stylus, and wherein the input/output circuitry is further configured to:
receive an input that indicates a selection of a type of tool, of a plurality of tools, for the stylus to emulate, wherein each tool of the plurality of tools is associated with one or more parameters indicating a manner of applying the XR visual effect for the respective tool, wherein the one or more parameters is based at least in part on stylus pressure data obtained from a sensor of the stylus in relation to the user; and
wherein the control circuitry is further configured to:
apply the XR visual effect to the user based at least in part on the type of tool.

20. The system of claim 15, wherein the object is a stylus, and wherein the position of the stylus comprises data of at least one of an angle of the stylus relative to the user, a tilt of the stylus relative to the user, a yaw of the stylus relative to the user, or a roll of the stylus relative to the user.

21.-130. (canceled)
